(19) United States
(12) Patent Application Publication
(10) Pub. No.: US 2025/0103057 A1
(43) Pub. Date: Mar. 27, 2025

(54) METHOD AND SYSTEM FOR ENHANCED LIFEFORM COLLISION AVOIDANCE

(71) Applicants: Ted JEWELL, Wolverine Lake, MI (US); Susan A. BUTLER, Milford, MI (US)

(72) Inventors: Ted JEWELL, Wolverine Lake, MI (US); Susan A. BUTLER, Milford, MI (US)

(21) Appl. No.: 18/973,382

(22) Filed: Dec. 9, 2024

Related U.S. Application Data
(60) Provisional application No. 63/608,918, filed on Dec. 12, 2023.

(51) Int. Cl. G05D 1/622; G05D 1/229; G05D 109/10; G05D 109/20; G05D 109/30

(52) U.S. Cl. CPC G05D 1/622; G05D 1/229; G05D 2109/10; G05D 2109/20; G05D 2109/30

(57) ABSTRACT

An enhanced lifeform transmission system to locate a lifeform (e.g., human, animal, etc.) wanting to be identified as a lifeform for collision avoidance. The lifeform transceiver is worn on a limb or neck of the lifeform. The collision avoidance system is housed inside the vehicle and receives communications from the lifeform transceiver. The lifeform is automatically detected and the lifeform transmitter is automatically turned on and off when a lifeform enters and exits a vehicle. The lifeform transceiver also tracks and protects the lifeform in a manufacturing facility or at an outdoor location.

### CROSS REFERENCES TO RELATED APPLICATIONS

This U.S. Utility patent application claims priority to U.S. Provisional patent application No. 63/608,918, filed Dec. 12, 2023, the contents of which are incorporated by reference.

### FIELD OF INVENTION

This invention relates to avoiding collisions with lifeforms including humans and animals. More specifically, it relates to a method and system for enhanced lifeform collision avoidance.

Ground vehicles (cars, school buses, public transportation, trucks, and the like), watercraft (boats, marine vehicles, and the like), and aircraft (drones, helicopters), airplanes, and the like), are now coming equipped with technological systems for collision avoidance. However, although safety for the driver and passengers of the vehicles are becoming safer, those outside of the vehicle or in the path of the vehicles are increasingly injured or killed by collisions. Radar retroreflectors may be detected by such systems and may be used to “mark” the locations of pedestrians to avoid collisions—for example, swimmers, small children or pets, road construction workers, a police officer pulling over a vehicle, a disabled vehicles where the operator is changing a tire, children exiting a school bus, vehicle repair persons, and persons with disabilities who may be unaware of vehicles in their vicinity.

The number of pedestrians killed along U.S. roadways last year climbed to the highest level since 1990, according to a new report. An estimated 6,227 pedestrians were killed in 2018, an increase of 250 from 2017, the Governors Highway Safety Association reported. The Association based its estimate on data collected by state highway safety offices. U.S. pedestrian fatalities have increased 41% since 2008 and now account for 16% of all traffic fatalities. 5,977 pedestrians were killed in traffic crashes in 2017 in the United States. This averages to one crash-related pedestrian death every 1.5 hours. Also, almost 137,000 pedestrians were treated in emergency rooms for non-fatal crash-related injuries in 2017. Pedestrians are 1.5 times more likely than passengers to be killed in a car crash. Persons aged 65 and older accounted for 20% of all pedestrian deaths in 2016 and an estimated 10% of all pedestrians injured in 2017. About 20% of the children under the age of 15 who were killed in traffic crashes in 2017 were pedestrians. The source of all of this data is published by the CDC, Motor Vehicle Safety, Pedestrian Safety at https://www.cdc.gov/motorvehiclesafety/pedestrian_safety/index.html).

America's growing love affair with pickups, SUVs and crossover utility vehicles means pedestrians are being hit by bigger, heavier, and more powerful vehicles. As a result, pedestrians who are hit are more likely to die or suffer life-threatening injuries, the association said. Pedestrian fatalities involving SUVs jumped by 50% between 2013 and 2017, it estimates. Another factor is the growing population in many states, which has led to more deadly encounters between drivers and pedestrians. The report also blames people being distracted by their smartphones and not being focused on the road as contributing to pedestrian fatalities. Add in a strong economy with relatively cheap gas prompting more people to drive more miles and it's a deadly recipe for people walking along roads or crossing streets.

Ten automakers reported equipping more than half of the vehicles they produced in 2018 with automatic emergency braking (AEB) according to the National Highway Traffic Safety Administration (NHTSA) and the Insurance Institute for Highway Safety (IIHS). This is the second update of manufacturer progress toward equipping every new passenger vehicle with the crash avoidance technology by Sep. 1, 2022. The 10 manufacturers include many high-volume automakers, such as Honda, Nissan and Toyota. Three manufacturers—Mercedes-Benz, Tesla and Volvo—report 93% or higher conformance with the voluntary commitment, with Tesla at 100%.

Although sensors are increasingly used in vehicle collision avoidance technology, sensors are still having problems identifying lifeforms and collisions still occur. According to AAA, Inc., cars with high-tech safety systems are still running people over.

Cameras, radar, and lidar have limitations when used outdoors for searching and rely on visibility and detection of lifeform. Cameras work poorly at night. Radar does not distinguish well between different types of objects. Lidar can fail completely in rain, snow, or fog. Most importantly it is relying on the vehicle ability to perform the detection, without augmented interaction and communication from outside the vehicle.

There have been various attempts to solve some of the problems associated with problems identifying lifeforms and avoiding collisions.

For Example, U.S. Patent Document No. 20160003933 (Calmettes; et al.) discloses “a system for locating a distress beacon, using a computer implemented method for processing the signal emitted by a distress beacon, The signal being received by several satellites and forwarded to at least one ground station, the method comprising the steps consisting in determining a set of hypothetical positions of the beacon, and for at least one of the hypothetical positions, for each satellite, offsetting the signal received and forwarded as a function of the hypothetical position; summing the offset signals; and evaluating the validity of the sum of the offset signals as a function of the presence of a predefined characteristic in the sum.”

U.S. Patent Document No. 20140092249 (Freilburger) discloses “a vehicle perimeter detection system for a vehicle having a plurality of sensors provided on an exterior of the vehicle for sensing an object in a peripheral field of view during motion of the vehicle. The plurality of sensors includes a front sensor configured for sensing substantially forward the vehicle, a rear sensor configured for sensing substantially rearward the vehicle; and a side sensor configured for sensing substantially laterally adjacent the vehicle. The perimeter detection system also has a controller for processing the plurality of sensors to detect the object in the peripheral field of view when the vehicle is stopped, such as when a transmission of the vehicle is in park. An output signal is generated that is indicative of the object detected in the peripheral field of view. The output signal may be audible and visual and may include a door lock signal and a window raising signal.”

U.S. Patent Document No. 20080238636 (Birging; et al.) discloses “a vehicle surveillance system having a plurality of side-light units mounted on opposite sides of a truck, bus, train or a similar long vehicle. The side-light units form an RF communication network on the vehicle. Each side-light unit comprises a day-running light source, a sensor for defining a surveillance zone on the side of said vehicle, said the sensor being arranged to detect an object or a movement of an object within the surveillance zone, and an RF transmitter which is controlled by said sensor and arranged to transmit an RF detection signal from said side-light unit. Existing day-running side-light units of a vehicle may be replaced with the inventive vehicle day-running side-light units.

U.S. Pat. No. 11,738,746 (Jewell) discloses “A lifeform transmission system is used to locate a lifeform wanting to be identified as a lifeform for collision avoidance. The lifeform transmission system comprises a lifeform vitals detector, a GPS transmitter and various other electrical circuits. The lifeform transmitter is worn on a limb or neck of the lifeform. If the lifeform does not wear a transmitter no signal is emitted. The collision avoidance system is housed inside the vehicle and receives communication from invention. If any lifeform is positioned in the path or approaching the path that the ground vehicle is traveling, the vehicle's collision avoidance system is advised to avoid the collision to enhance the accuracy of the collision avoidance system. This invention complements the existing collision avoidance system and enhances the accuracy of vehicle systems by providing an input from the lifeform, making detection easier.”

U.S. Pat. No. 10,109,174 (Troxler) discloses “a system for detecting position and proximity. According to one aspect, a computing device includes a processor configured to determine a position coordinate of a first movable device. Further, the processor is configured to determine whether the position coordinate of the first movable device is a predetermined distance from a second movable device. The processor is also configured to signal the second movable device in response to determining that the position coordinate of the first movable device is a predetermined distance from a second movable device.”

U.S. Pat. No. 9,237,855 (Hong, et al.) discloses “a wearable heart rate monitor. Some embodiments provide a wearable fitness monitoring device including a motion sensor and a photo-plethysmographic (PPG) sensor. The PPG sensor includes (I) a periodic light source, (ii) a photo detector, and (iii) circuitry determining a user's heart rate from an output of the photo detector. Some embodiments provide methods for operating a heart rate monitor of a wearable fitness monitoring device to measure characteristics of a heartbeat waveform.”

However, these solutions still do not solve all of the problems associated with collision avoidance of humans and animals. Thus, it is desirable to solve some of the problems associated with collision avoidance of humans and animals.

### SUMMARY OF THE INVENTION

In accordance with preferred embodiments of the present invention, some of the problems associated with collision avoidance of humans and animals are solved. A method and system for enhanced collision detection of lifeforms is presented.

An enhanced lifeform transmission system to locate a lifeform (e.g., human, animal, etc.) wanting to be identified as a lifeform for collision avoidance. The lifeform transceiver is worn on a limb or neck of the lifeform. The collision avoidance system is housed inside the vehicle and receives communications from the lifeform transceiver. The lifeform is automatically detected and the lifeform transmitter is automatically turned on and off when a lifeform enters and exits a vehicle. The lifeform transceiver also tracks and protects the lifeform in a manufacturing facility or at an outdoor location.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating lifeform transmission system for a ground vehicle;

FIG. 2 is a block diagram illustrating an environmental view of the lifeform transmission system of FIG. 1;

FIG. 3 is a block diagram illustrating an exemplary lifeform transmitter/signal emitter for a human lifeform for the lifeform detection system of FIG. 1, including a watch;

FIG. 4A is a block diagram illustrating an exemplary lifeform transmitter/signal emitter for a non-human lifeform for the lifeform detection system of FIG. 1, including a pet collar;

FIG. 4B is a block diagram illustrating an exemplary lifeform transmitter/signal emitter for a non-human lifeform for the lifeform detection system of FIG. 1, including a dog;

FIG. 5A is a block diagram illustrating a second environmental view of the lifeform transmission system of FIG. 1 with aircraft;

FIG. 5B is a block diagram illustrating a third environmental view of the lifeform transmission system of FIG. 1 with watercraft;

FIG. 5C is a block diagram illustrating a fourth environmental view of the lifeform transmission system of FIG. 1 with watercraft and aircraft;

FIG. 6A is block diagram illustrating components of a lifeform transmitter/signal emitter for the lifeform transmission system of FIG. 1;

FIG. 6B is block diagram illustrating construction of an electrical signal of a lifeform transmitter/signal emitter for the lifeform transmission system of FIG. 1.

FIG. 6C is a block diagram illustrating a data flow of a lifeform transmitter/signal emitter for the lifeform transmission system of FIG. 1;

FIG. 7 is a block diagram illustrating components of a lifeform receiver/detector for the lifeform transmission system of FIG. 1;

FIG. 8A is a flow diagram illustrating a method for lifeform detection using a ground vehicle of FIG. 1;

FIG. 8B is a flow diagram illustrating a method for lifeform detection using aircraft with a ground vehicle of FIG. 1;

FIG. 8C is a flow diagram illustrating a method for lifeform detection using watercraft and a ground vehicle of FIG. 1;

FIG. 8D is a flow diagram illustrating a method lifeform detection using aircraft and watercraft of FIG. 1;

FIGS. 9A and 9B is a flow diagram illustrating a method for enabling and disabling lifeform protection;

FIGS. 10A and 10B are a flow diagram illustrating a method for enabling and disabling lifeform protection;

FIG. 11 is a flow diagram illustrating a method for enabling and disabling a lifeform protection;

FIGS. 12A and 12B are a flow diagram illustrating a method for enabling and disabling a lifeform protection;

FIG. 13 is a flow diagram illustrating a method for enabling and disabling a lifeform protection;

FIG. 14 is a flow diagram illustrating a method for enabling and disabling a lifeform protection;

FIG. 15 is a flow diagram illustrating a method for enabling and disabling a lifeform protection; and

FIG. 16 is a flow diagram illustrating a method for enabling and disabling a lifeform protection.

### DETAILED DESCRIPTION OF PREFERRED EMBODIMENTS

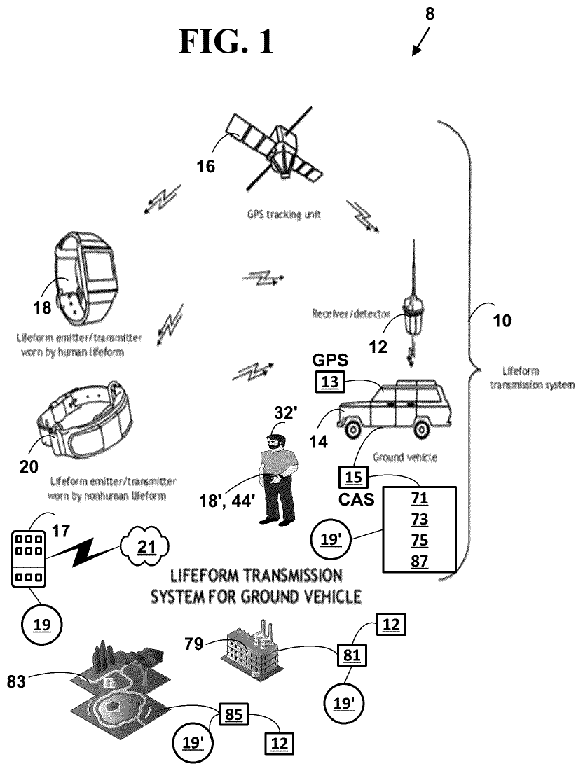

FIG. 1 is a block diagram 8 illustrating a lifeform transmission system 10 for a ground vehicle.

FIG. 1 includes a lifeform detector/receiver 12 with one or more processors, mounted atop a ground vehicle 14 with a collision avoidance system (CAS) 15 (also included in aircraft, watercraft, etc.) including the lifeform detector/receiver 12 being in one way communication with a global positioning satellite 16, a lifeform transmitter/signal emitter 18 with one or more processors, for a human lifeform, a non-human lifeform transmitter signal emitter 20 with one or more processors for a non-human lifeform (e.g., pet, etc.). the lifeform transmitter/signal emitter 18 and the non-human lifeform signal emitter in electronic communications with a receiver/detector 20 with one or more processors located in and/or on the ground vehicle 14. The system 10 further includes one or more external network devices 17 (e.g., cell phone, smart phone, electronic tablet, other wearable network device (e.g., watch, bracelet, glasses, sensors, monitors, etc., laptop computer, only one is illustrated for simplicity, etc.) with one or more processors and a lifeform detection application 19 connected to a communications network 21 to control the lifeform transmitter/signal emitter 18, 20. The ground vehicle 14 further includes a Global Positioning System (GPS) 13 component. However, the present invention is not limited to such an embodiment, and more, fewer and/or other component can be used in the lifeform transmission system 10 to practice the invention.

The applicant of this patent application is same the applicant of U.S. Pat. No. 11,738,746, that issued on Aug. 29, 2023, teaches a method and system for lifeform collision avoidance, the contents of which, is incorporated by reference.

The term “lifeform” as used herein, includes, but is not limited to, an organism such as a human, pet, livestock, or other animal.

The term “lifeform vitals” includes, but is not limited to one or more measurements that confirms a lifeform. Lifeform vitals include lifeform biometrics such as body temperature, blood pressure, heartbeat, pulse, respiration rate, oxygen consumption, respiration rate, etc. and/or equivalent.

The term “vehicle” as used herein includes, but is not limited to, any manned or unmanned powered machine that moves along the surface of the land that transports lifeforms, cargo, or both, including but not limited to a car, truck, bus, van, snowmobile, sports utility vehicle, recreational vehicle, or motorcycle. The vehicle is either a land craft, an aircraft (plane, helicopter, drone), or a watercraft (boats, personal watercrafts (PWC), that patrol near the shores of bodies of water). A vehicle includes a Global Positioning System (GPS) component to determine its own currently physical location.

The term “collision avoidance system (CAS)” 15 as used herein includes, but is not limited to, a pre-crash system, forward collision warning system, or collision mitigating system, designed to prevent or reduce the severity of a collision. Typically, this system uses radar (all-weather) and sometimes laser and one or more cameras (employing image and facial recognition) or combination to detect presence of a moving object as an imminent or potential crash. This system uses but not limited to a camera, thermal imaging camera Light Detection And Ranging (LiDAR) component, Light Detection and Ranging (LADAR), radar, Wi-Fi, laser, sonar, Radio Frequency Identifier (RFID), 802.11p wireless access in vehicular environments, CV2x (i.e., real-time optimized Computer Vision), equivalent/similar, or some combination of these to identify lifeforms either in or near a travel path of the vehicle. This system then warns the driver through a system warning and could assist or stop the vehicle when a potential critical situation is detected, and driver of vehicle does not respond.

The term “GPS” as used herein includes, but is not limited to, Global Positioning System (GPS) is a worldwide radio-navigation system formed from the constellation of 24 satellites and their ground stations. Global Positioning System tracking is a method of working out exactly where something is. A GPS tracking system, for example, may be placed in a vehicle, on a cell phone, or on special GPS devices, which can either be a fixed or portable unit. GPS works by providing information on exact location. It can also track the movement of a vehicle or person. A GPS tracking system uses the Global Navigation Satellite System (GNSS) network.

The GPS network incorporates a range of satellites 16 that use microwave and/or other signals that are transmitted to GPS devices to give information on location, vehicle speed, time and direction. So, a GPS tracking system can potentially give both real-time and historic navigation data on any kind of journey. GPS provides special satellite signals, which are processed by a receiver. These GPS receivers not only track the exact location but can also compute velocity and time. The positions can even be computed in three-dimensional views with the help of four GPS satellite signals. The Space Segment of the Global Positioning System consists of 27 Earth-orbiting GPS satellites. There are 24 operational and 3 extra (in case one fails) satellites that move round the Earth each 12 hours and send radio signals from space that are received by the GPS receiver.

The term “BLUETOOTH®” as used herein includes, but is not limited to, a Bluetooth transceiver that operates on Bluetooth protocols. As used herein, Bluetooth includes Bluetooth, ULP Bluetooth (Ultra Low Power Bluetooth), BLE (Bluetooth Low Energy), and other standards sets by Bluetooth SIG.

The main function of the invention is to transmit a locating GPS (or equivalent) signal that is then read by the collision avoidance system in a vehicle. This signal is only transmitted when lifeform vitals are identified. This electrical signal is only a transmitting, one-way communication device. The signal changes as the lifeform moves and collision avoidance system can detect this and therefore use it to control the movement of the vehicle. The lifeform may have controls to turn this signal on and off.

The main parts of the lifeform transmission system of the present invention are as follows: Lifeform vitals. These are obtained through using sensors and associated electronics. It can be human or nonhuman (pets). GPS transmitter/emitter circuit. The lifeform transmission system of the present invention has a GPS receiver that can receive the location data from the satellite. Physical attachment/enclosure to house the above elements. Software elements are present and integrated into the product. These include but not limited to over the air software updates, monitoring system performance parameters etc. Battery and battery charging systems are not shown separately however they are part of system operation.

The main function of the lifeform detection system of the present invention is to make lifeforms outside the vehicle identifiable regarding the proximity of the lifeform and the directional path of the lifeform relative to the directional path of the vehicle. In this way the lifeform detection system of the present invention enhances the accuracy and effectiveness of existing collision avoidance systems, thereby increasing the level of identifiable lifeforms and reducing collisions. If a device is not worn, it cannot register a lifeform and therefore no signal is emitted. While the system main function is to transmit the locating signal, the vehicle system will be able to detect lifeform using this device.

The lifeform transmission system of the present invention relates to a collision avoidance systems in/between existing and future vehicles, or centralized traffic coordinating system, and more particularly, to systems that enable lifeform recognition in the travel path of the vehicle or traveling toward the travel path of the vehicle to be identified or noted as a lifeform by the vehicle to avoid any collision with the lifeform, or notify the driver of the vehicle to use caution, and possibly the autonomous driving features to encourage manual attention, or pull off to the shoulder of the road if driver is un-attentive. The key is the device wearer being registering a lifeform through vital information such as body temperature, pulse, oxygen consumption and/or other lifeform specific vitals identifiers. When the device registers the lifeform, the device emits the signal identifying the lifeform as a lifeform. If this signal is received by a vehicle, the vehicle may communicate to the driver, of lifeform proximity and to use caution. Existing collision avoidance systems may be engaged to stop the vehicle, if the vehicle driver is not able to act quickly. If transmitter device is not worn, it cannot register a lifeform and therefore no signal is emitted. While the system main function is to transmit the locating signal, the vehicle system will be able to detect lifeform using this device.

The lifeform transmission system is used to locate a lifeform wanting to be identified as a lifeform for collision avoidance purposes. The lifeform transmission system comprises a lifeform vitals detector, a GPS transmitter and various other electrical circuits. The invention is worn on a limb or neck of the lifeform. If device is not worn, no signal is emitted. The collision avoidance system is housed inside the vehicle and receives communication from invention. If any lifeform is positioned in the path or approaching the path that the ground vehicle is traveling, the collision avoidance system of the vehicle is advised to avoid the collision to enhance the accuracy of the collision avoidance system. The lifeform transmission system of the present invention complements the existing collision avoidance system and enhances the accuracy of vehicle systems by providing an input from the lifeform, making detection easier.

Returning to FIG. 1, the lifeform transmitter/signal emitter 18 is illustrated as a wearable network device with one or more processors including a watch. However, the present invention is not limited to such an embodiment and the lifeform transmitter/signal emitter 18 can be included as a component of a backpack, a necklace, a bracelet, etc.

The lifeform transmitter/signal emitter 18 for the human lifeform and the non-human lifeform transmitter signal emitter 20 for the non-human lifeform will each preferably include a power source (i.e., a rechargeable battery, etc.), a power source charger, software, over the air programming, a physical enclosure, charging ports, and means to attach to a limb or neck to the lifeform or means of physical connection (i.e., touching of the skin to engage the lifeform recognition-sensor functions, etc.). However, the present invention is not limited to such embodiments and other embodiments may be used to practice the invention.

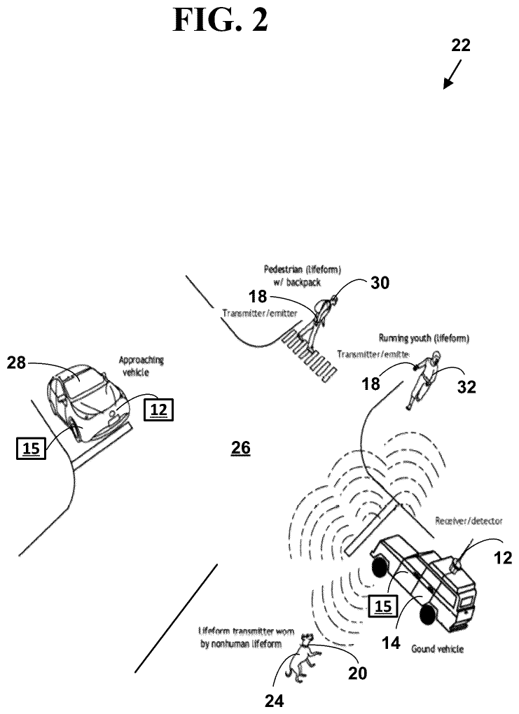

FIG. 2 is a block diagram 22 illustrating an environmental view of the lifeform transmission system 10 of FIG. 1.

In FIG. 2 illustrates the lifeform transmission system 10 transmitting a position of a non-human life form 24 (e.g., a dog, etc.) on a street 26 wearing the non-human lifeform transmitter signal emitter 20, an approaching vehicle 28, a human adult pedestrian 30 with a backpack crossing the street 26 and the lifeform transmitter/signal emitter 18 for a human, a running human youth 32, wearing the lifeform transmitter/signal emitter 18 for a human, the ground vehicle 14 with lifeform detector/receiver 12.

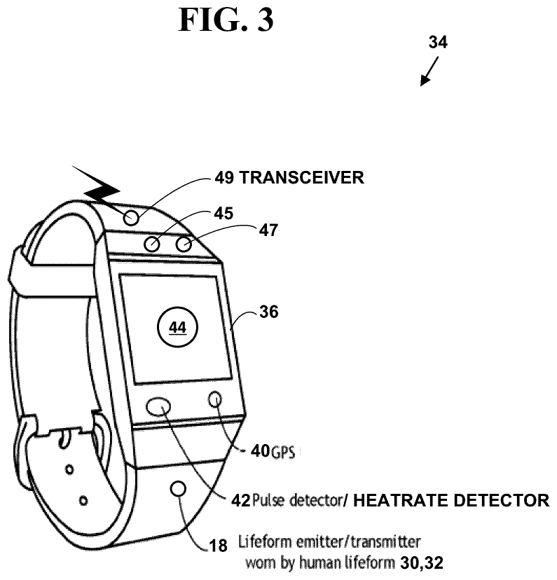

FIG. 3 is a block diagram 34 illustrating an exemplary lifeform transmitter/signal emitter 18 for a human lifeform 30, 32 for the lifeform detection system 10 of FIG. 1 including a watch 36.

In one embodiment, the watch 36 includes, but is not limited to a sports/running/exercise watch (e.g., GARMIN, FITBIT, APPLE, etc.) with a pulse and/or heartrate detector and a GPS component. In another embodiment, the exemplary lifeform transmitter/signal emitter 18 for a human lifeform includes a sports/running/exercise bracelet (e.g., FITBIT, HERMES, etc.) and/or other wearable network device. However, the present invention is not limited to such embodiments and other embodiments may be used to practice the invention.

In FIG. 3 the exemplary lifeform transmitter/signal emitter 18 for a human lifeform includes a sports watch with a GPS component 38 used to provide an actual physical location of a human lifeform 30, 32 and a pulse/heartrate detector 40 to confirm to confirm the exemplary lifeform transmitter/signal emitter 18 is actually being worn by a human lifeform 30, 32 with a detectable pulse and/or a detectable heartrate.

In one embodiment, the exemplary lifeform transmitter/signal emitter 18 includes a lifeform application 44 for initializing and controlling a lifeform signal. In another embodiment, the exemplary lifeform transmitter/signal emitter 18 includes a software, hardware, firmware and/or combination thereof lifeform signal emitter. However, the present invention is not limited to such an embodiment and other embodiments can be used to practice the invention.

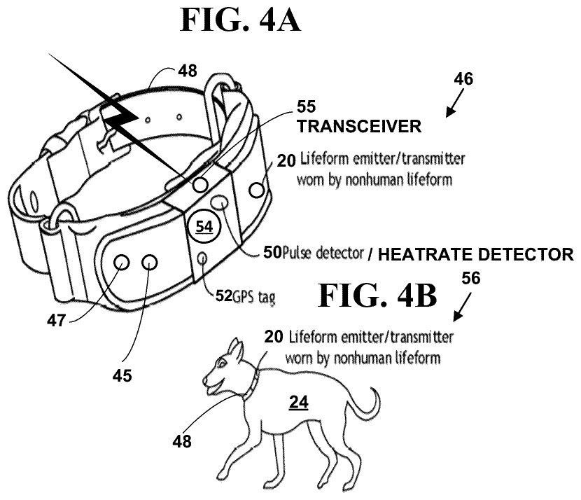

FIG. 4A is a block 46 diagram illustrating an exemplary lifeform transmitter/signal emitter 20 for a non-human lifeform 24 for the lifeform detection system of FIG. 1, including a pet collar 48.

In one embodiment, the pet collar 48 includes, but is not limited to, a LINK AKC Smart Collar, a FITBARK Smart Collar, etc. However, the present invention is not limited to such an embodiment and other embodiments can be used to practice the invention.

In FIG. 4A the exemplary lifeform transmitter/signal emitter 20 for a non-human lifeform includes a pet collar 48 with a GPS component 50 used to provide an actual physical location of a non-human lifeform 24 and a pulse/heartrate detector 52 to confirm to confirm the exemplary non-human lifeform transmitter/signal emitter 20 is actually being worn by a non-human lifeform 24 with a detectable pulse and/or a detectable heartrate.

In one embodiment, the exemplary non-human lifeform transmitter/signal emitter 20 includes a non-human lifeform software application 54 for initialing and controlling a lifeform signal. In another embodiment, the exemplary non-human lifeform transmitter/signal emitter 20 includes a software, hardware, firmware and/or combination thereof the non-human lifeform signal emitter 20. However, the present invention is not limited to such an embodiment and other embodiments can be used to practice the invention.

FIG. 4B is a block diagram 56 illustrating an exemplary lifeform transmitter/signal emitter 20 for a non-human lifeform 24 for the lifeform detection system 10 of FIG. 1, including a dog 24 with a pet collar 48.

The lifeform detection system 10 of FIG. 1 can be used to search for a lifeform including human lifeforms 30, 32 and non-human life forms 24 using aircraft and ground vehicles.

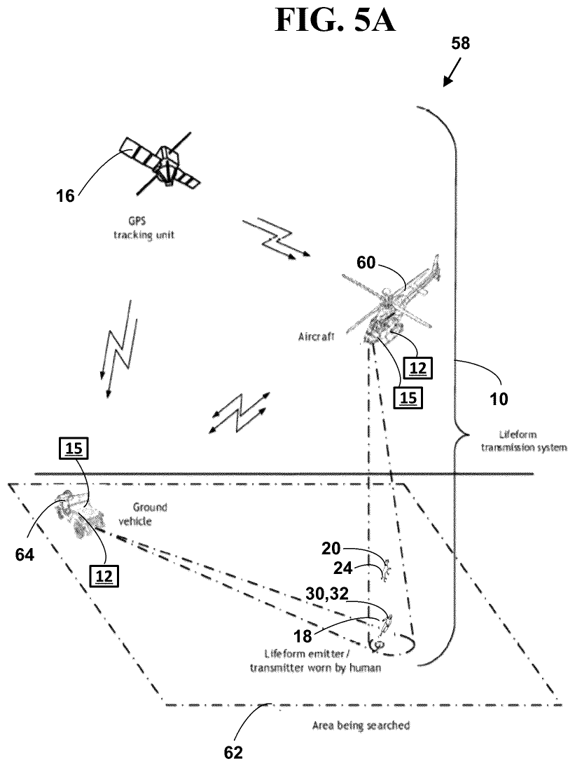

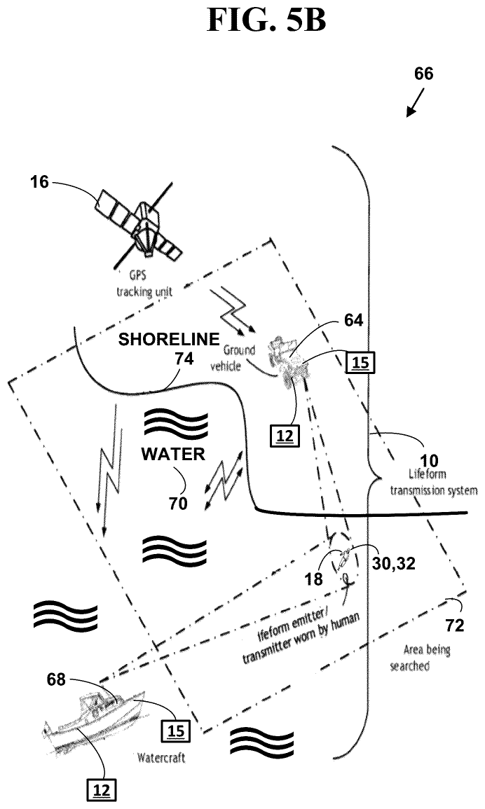

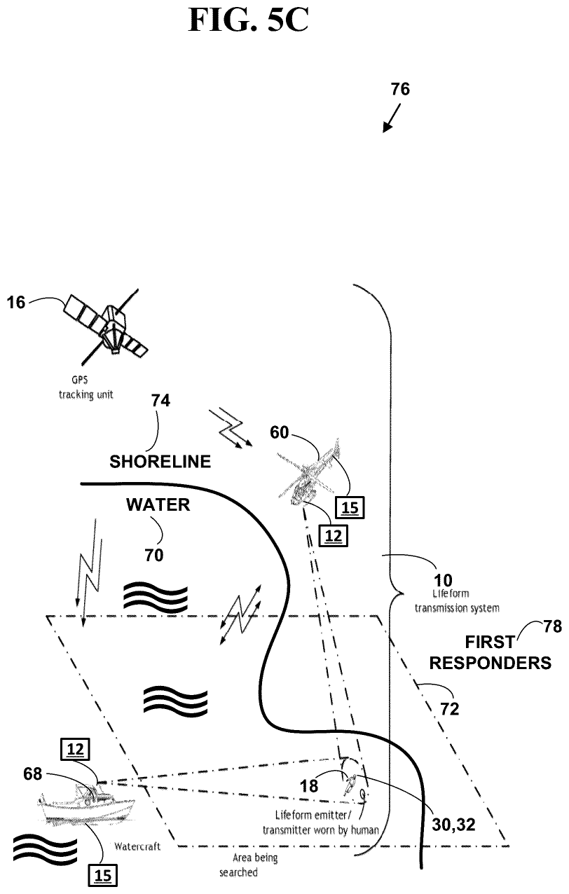

FIG. 5A is a block diagram 56 illustrating a second environmental view of the lifeform transmission system 10 of FIG. 1.

FIG. 5A illustrates an aircraft 60 (e.g., helicopter, airplane, drone, etc.) with a lifeform detector/receiver 12 that scans quadrant coordinates in a search area 62 where a lifeform 24, 30, 32 is with a lifeform transmitter/signal emitter 18 for a human lifeform and/or an exemplary lifeform transmitter/signal emitter 20 for a non-human lifeform. The GPS satellite 16 provides current GPS current physical location for a lifeform 24, 30, 32. The aircraft 60 communicates any findings to a ground vehicle 64, with a lifeform detector/receiver 12 proximate to the search area 62. The lifeform detector/receiver 12 in the ground vehicle 64 uses t lifeform detector/receiver 12 to locate the lifeform 24, 30, 32.

The lifeform detection system 10 of FIG. 1 can be used to search for a lifeform including human lifeforms 30, 32 and non-human life forms 24 in a body of water using watercraft and ground vehicles.

FIG. 5B is a block diagram 66 illustrating a third environmental view of the lifeform transmission system 10 of FIG. 1 with watercraft.

FIG. 5B illustrates a watercraft 68 (e.g., boat, ship, personal watercraft, etc.) with a lifeform detector/receiver 12 that scans quadrant coordinates in a body of water (e.g., lake, river, ocean, pond, etc.) in a search area 72 where a lifeform 24, 30, 32 is with a lifeform transmitter/signal emitter 18 for a human lifeform and/or an exemplary lifeform transmitter/signal emitter 20 for a non-human lifeform. The GPS satellite 16 provides current GPS current physical location for a lifeform 24, 30, 32. The watercraft 68 communicates any findings to a ground vehicle 64 on a shoreline 74 with a lifeform detector/receiver 12 proximate to the search area 72. The lifeform detector/receiver 12 in the ground vehicle 64 uses t lifeform detector/receiver 12 to locate the lifeform 24, 30, 32. Only a human lifeform 30, 32 is illustrated in FIG. 5 for simplicity.

FIG. 5C is a block diagram 76 illustrating a fourth environmental view of the lifeform transmission system of FIG. 1 with watercraft 68 and aircraft 60.

FIG. 5C illustrates an aircraft 60 (e.g., helicopter, airplane, drone, etc.) with a lifeform detector/receiver 12 and watercraft 68 (e.g., boat, ship, personal watercraft, etc.) with a lifeform detector/receiver 12 that scans quadrant coordinates in a body of water (e.g., lake, river, ocean, pond, etc.) in a search area 72 where a lifeform 24, 30, 32 is with a lifeform transmitter/signal emitter 18 for a human lifeform and/or an exemplary lifeform transmitter/signal emitter 20 for a non-human lifeform. The GPS satellite 16 provides current GPS current physical location for a lifeform 24, 30, 32. The aircraft 60 and watercraft 68 communicate any findings to first responders 78 on a shoreline 74 with a lifeform detector/receiver 12 proximate to the search area 72. The lifeform detector/receiver 12 in the ground vehicle 64 uses the lifeform detector/receiver 12 to locate the lifeform 24, 30, 32. Only a human lifeform 30, 32 is illustrated in FIG. 5 for simplicity.

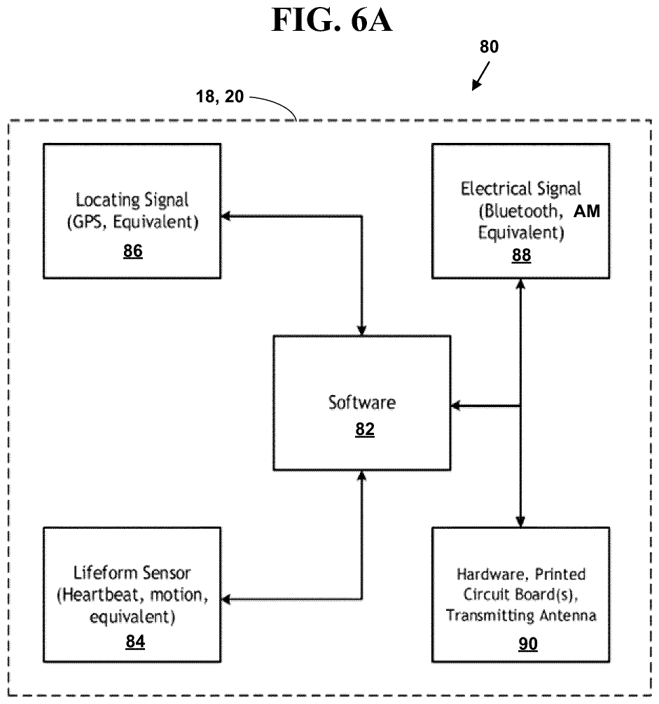

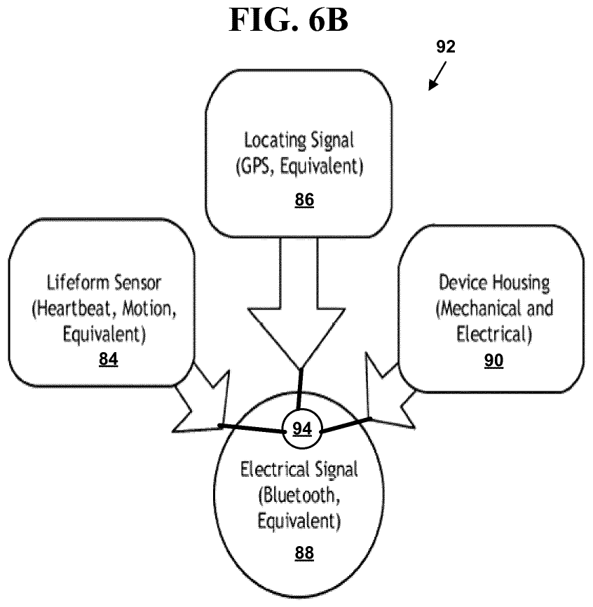

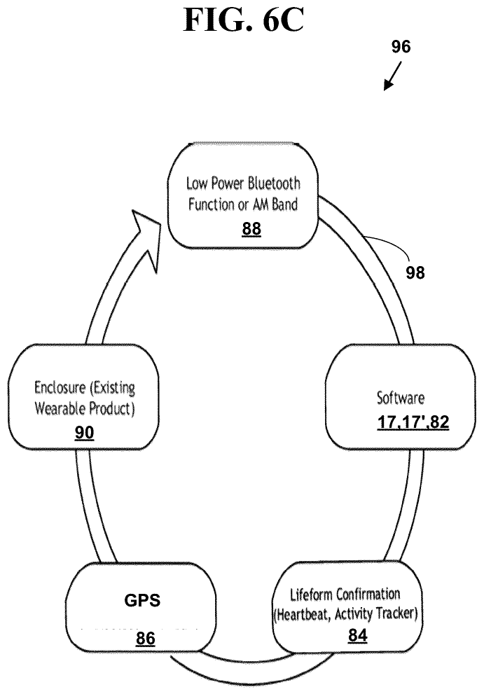

FIG. 6A is block diagram 80 illustrating components of the lifeform transmitter/signal emitter 18, 20 for the lifeform transmission system 10 of FIG. 1.

FIG. 6A illustrates emitter software 19, 19′ 82 for the vital-signs sensor 84. The wearable transmitter 18, 20 transmits a unique wireless locating signal 86 (e.g., GPS, etc.) using a BLUETOOTH, low power and/or AM radio band lifeform electrical signal 88 and/or other signal type/function. Moving vehicles 14. 28, 64 use this signal to know that a lifeform 24, 30, 32 wearing a detector 18, 20 is in proximity, updating a collision avoidance system 15 of the vehicle 14, 28, 64, preventing a collision with the lifeform 24, 30, 32, In one preferred embodiment, the lifeform electrical signal 88 is only transmitted when the device 18, 20 senses lifeform 24, 30, 32 vitals 84. A non-lifeform object cannot generate this lifeform signal 88 preventing misuse. In a second preferred embodiment, the lifeform signal 88 continues to transmit, even absent lifeform vitals 84 or motion 86, however the receiver 12 receives a lifeform signal 88 without lifeform information 84 and recognizes the object as a non-lifeform. However, the present invention is not limited to such embodiments and other embodiments can be used to practice the invention.

In another embodiment, the BLUETOOTH and/or AM radio signal is replaced with a Near Field Communications (NFC), Machine-to-Machine (M2M), 802.11XX, FM radio, Satellite radio, and/or other Radio Frequency (RF), signal.

FIG. 6B is block diagram 92 illustrating construction of an electrical signal 88 of the lifeform transmitter/signal emitter 18, 20 for the lifeform transmission system 10 of FIG. 1.

In FIG. 6B, a lifeform signal 84 (a heartbeat, pulse, motion, etc.), a locating signal 86 (e.g., GPS, etc.) and signals from the hardware 90 are combined 94 to create an electrical signal 88 (e.g., BLUETOOTH, etc.).

FIG. 6C is a block diagram 96 illustrating a data flow 98 of a lifeform transmitter/signal emitter 18, 20 for the lifeform transmission system 10 of FIG. 1.

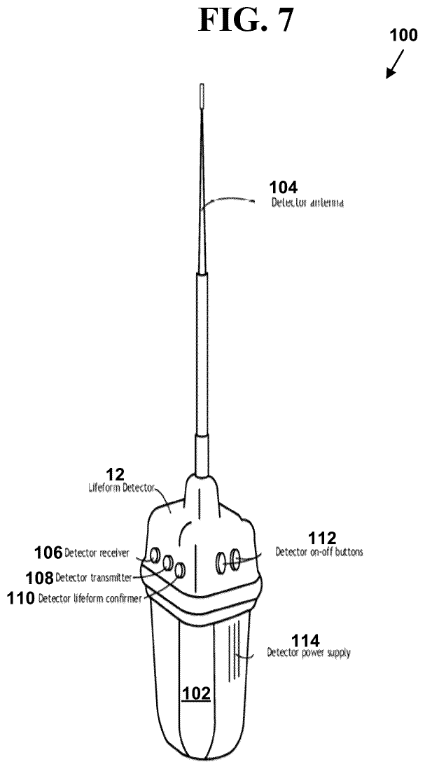

FIG. 7 is a block diagram 100 illustrating components of a lifeform receiver/detector 12 for the lifeform transmission system 10 of FIG. 1.

FIG. 7 lifeform receiver/detector 12 with a case 102, a detection antenna 104, a detection receiver indicator light 106, a detection transmitter light 108, a lifeform 24, 30, 32 detection confirmation light 110, an off/on button 112, and a power supply 114.

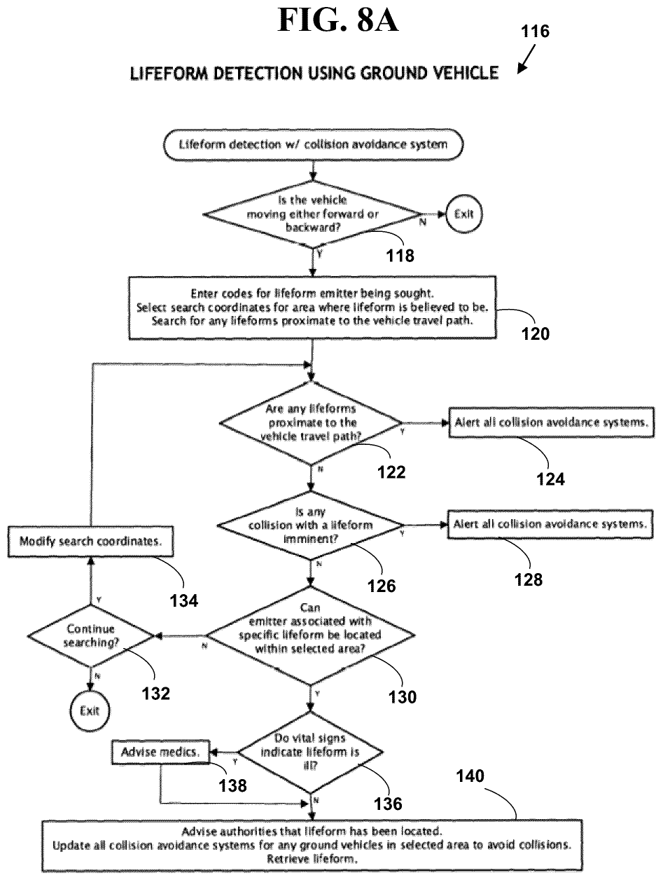

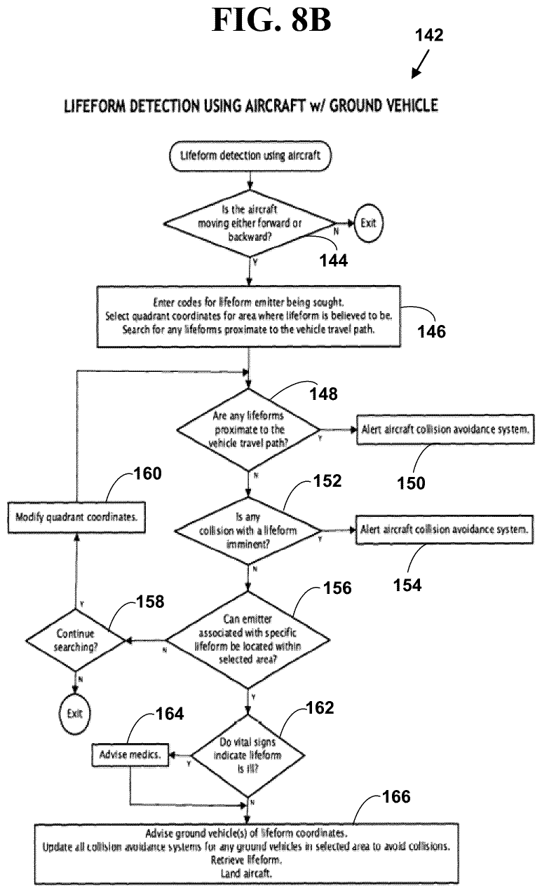

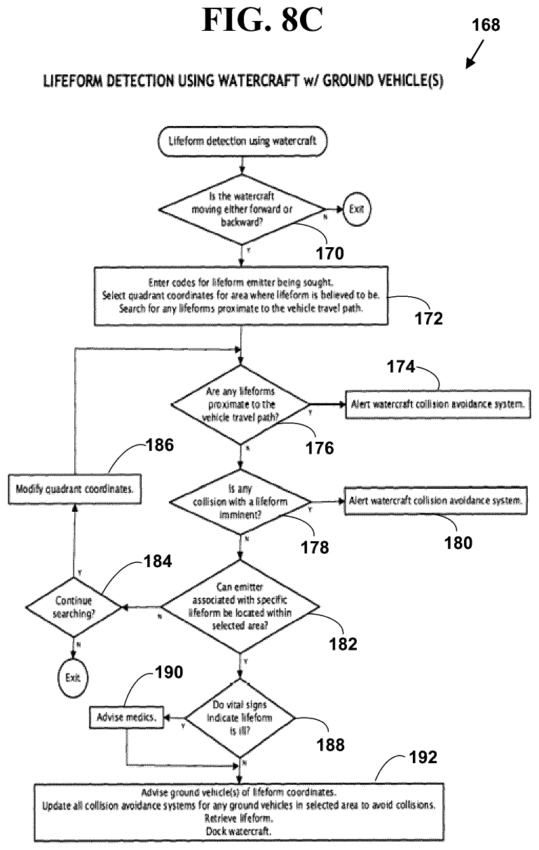

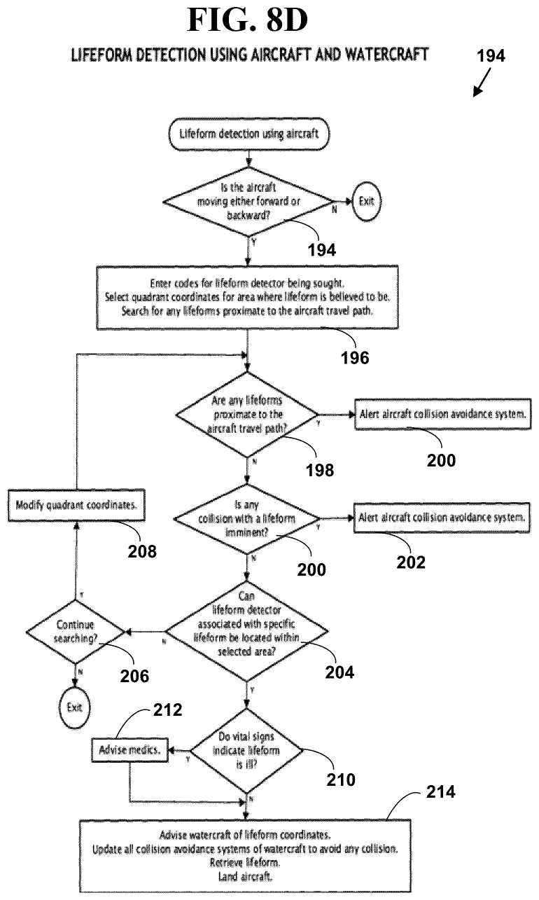

FIG. 8A is a flow diagram illustrating a Method 116 for lifeform detection using a ground vehicle 14, 30, 62 of FIG. 1. Method 114 includes text for steps 118-140 as illustrated on the FIG. 8A.

FIG. 8A depicts a flowchart illustrating use of the lifeform transmission system 10 of the present invention, deploying a ground vehicle 14, 30, 62 to search 72 within quadrant coordinates where the lifeform 24, 30, 32 is while continuously alerting the collision avoidance system 15 of the ground vehicle 14, 30, 62 of any lifeform 24, 30, 32 emitters proximate to the ground vehicle 24, 30, 32 travel path.

FIG. 8B is a flow diagram illustrating a Method 142 for lifeform detection using a ground vehicle 14, 30, 62 and aircraft 60 of FIG. 1. Method 142 includes text for steps 144-166 as illustrated on the FIG. 8B

FIG. 8B depicts a flowchart showing the second preferred embodiment of the lifeform transmission system 10 of the present invention, deploying an aircraft 60 to search 72 within quadrant coordinates where the lifeform 24, 30, 32 is while continuously alerting the collision avoidance system 15 of the aircraft 60 of any lifeform 24, 30, 24 emitters 18, 20 proximate to the aircraft 60 travel path, the aircraft 60 coordinating with one or more ground vehicles 14, 30, 62.

FIG. 8C is a flow diagram illustrating a Method 168 for lifeform 24, 30, 32 detection using watercraft 68 and a ground vehicle 14, 30, 62 of FIG. 1. Method 142 includes text for steps 170-194 as illustrated on the FIG. 8C.

FIG. 8C depicts a simplified flowchart showing the third preferred embodiment of the lifeform transmission system 210 of the present invention, deploying a watercraft 68 to search 72 within quadrant coordinates where the lifeform 24, 30, 32 is while continuously alerting the collision avoidance system 15 of the watercraft 68 of any lifeform emitters 18, 20 proximate to the watercraft 68 travel path, the watercraft 69 coordinating with one or more ground vehicles 14, 30, 62.

FIG. 8D is a flow diagram illustrating a Method 194 for lifeform 24, 30, 32 detection using aircraft 60 and watercraft 68 of FIG. 1. Method 194 includes the text for steps 196-214 as illustrated on FIG. 8D.

FIG. 8D depicts a simplified flowchart showing the fourth preferred embodiment of the lifeform transmission system 10 of the present invention, deploying an aircraft 60 to search 72 within quadrant coordinates where the lifeform 24, 30, 32 is while continuously alerting the collision avoidance system 15 of the aircraft 60 of any lifeform 24, 30, 32 emitters 18, 20 proximate to the aircraft 60 travel path, the aircraft 22 coordinating with one or more watercraft 68.

### Enhanced Lifeform Protection System

The method and system for lifeform protection is enhance by allowing a lifeform protection emitter 18, 20, on a lifeform 24, 30, 32 to be automatically turned off and on with several different methods when a lifeform enters and exits a vehicle. In another embodiment, the method and system for lifeform protection is manually turned off and on with several different methods when a lifeform enters and exits a vehicle. The enhanced lifeform protection systems provide additional flexibility, for lifeform protection emitter 18, 20, on the lifeform 24, 30, 32, for various types of vehicles and for integration with existing collision detection systems in various types of vehicles, at manufacturing facilities and at outdoor locations.

In one embodiment, occupants 30, 32 of a vehicle wearing the device 18 may emit a signal after boarding or entering into a vehicle 14, 28, 64 with a reception device 12, 15. As the student and/or 30, 32 gets onto the bus 14, 28 64, the device 18, 20 turns off while on the bus 14, 28, 64 and turns on as the rider 30, 32 exits the bus 14, 28, 64. This allows the bus 14, 28, 64, driver and/or operator of the bus 14, 28, 64 not to receive a signal. The bus only wants to receive a signal for persons/pets 24, 30, 32 outside of the vehicle 14, 28, 64 to avoid collision. There are a large number of wireless signals emitted if all occupants 30, 32 of the bus are emitting a signal in parallel. Therefore, it is critical for the device 18, 20 to be automatically turned off as the occupant 30, 32 enters the bus or vehicle. The vehicle may emit a wireless signal that the device 18 will pick up and tell the device 18 to stop emitting a signal, or as the occupant 30, 32 departs the vehicle, the device to turn back on.

In one embodiment, the invention includes a capability for the wearer of the device 18 to have a specific unique identification in the wireless signal. For example, if the wearer 30, 32 is an owner of a weapon or handgun, the wearer 30, 32 can be identified. Only the permitted living owner 30, 32 may fire the weapon as the weapon receives a specific unique identifier signal for the device 18. The device 18 is used for an additional level of security and function where needed and also be used in cases where non-living objects or assets may be tracked while emitting a signal.

In one embodiment, the present invention includes a wearable device 18, 36 with an accompanying monitoring system 12, 81, 85 can be used by utility workers, cave explorers, search & rescue workers, etc. to enter a confined space. The wearable device 18, 36 may be used in search and rescue to locate a human 30, 32 and/or pet 24 that is lost or buried under debris. In the event of a natural disaster and/or emergency situation, as long as the person 30, 32 and/or pet 24 is alive and generating biometrics, the device 18, 20, 36, 48 emits a signal for the person 30, 32 and/or pet to be located. The wearable device is 18, 20, 36, 48 includes a wearable unit incorporated within a wrist-mounted device which is in contact with the skin, or a device mounted in safety glasses, prescription glasses, or helmet with cameras to monitor a wearer in a confined space application where toxic gases could be present. In one embodiment, the wearer 30, 32 would use the wearable device 18, 20, 36, 48 to read ambient gas content while monitoring the wearer's vital signs, etc.

In one embodiment, based on biometric measurements, a monitoring device 12, 81, 95 would not only read the ambient gas content but also set an alarm if the wearer 24, 30, 32 is exposed to certain limits that would be considered increasingly toxic, to the point that toxicity may cause the wearer 24, 30, 32 to pass out and therefore, require to be rescued. The wearer's biometrics heart rate, blood oxygen level, body temperature, blood pressure, respiration, oxygen consumption or a combination of these parameters.

In another embodiment, the present invention includes a wearable device 18, 36 is incorporated within safety glasses or a helmet with built-in cameras that monitor physical condition of the wearer 30, 32. As the wearer's 30, 32 condition in a manufacturing facility 79 and/or outdoor location 83 is declining, a warning signal is provided to the wearer 30, 32 and to the monitoring device 12, 81, 85 which is observed by an independent person outside the confined pace to indicate that the wearer 30, 32 is affected by the surrounding environment and needs to be removed from the environment 79, 83 and brought to safety immediately. In all such instances, a coordinate-based system involving accelerometers and gyroscopes is with the wearable device 18, 36 utilized to determine (XYZ) position within the confined space. In some instances, it, additional amplification devices are utilized within such a system, depending on signal strength. If signal must be amplified, the wearable device 18, 36 alerts the wearer 30, 32 to drop an amplifier in the location where signal is still strong enough to relay data back to the monitoring device 12, 81, 85.

In one embodiment, a wireless signal may be implemented in search and rescue scenarios where multiple partner devices may be incorporated within such a system of devices for confined space entry (e.g. one local monitor above ground at a safe location for monitoring of the wearer as the wearer enters confined space and completes tasks requiring such entry and another monitor device at a ‘home station’ such as a First Responder's base station located elsewhere.

However, the present invention is not limited to these scenarios and embodiments and other embodiments can be used to practice the invention in other scenarios.

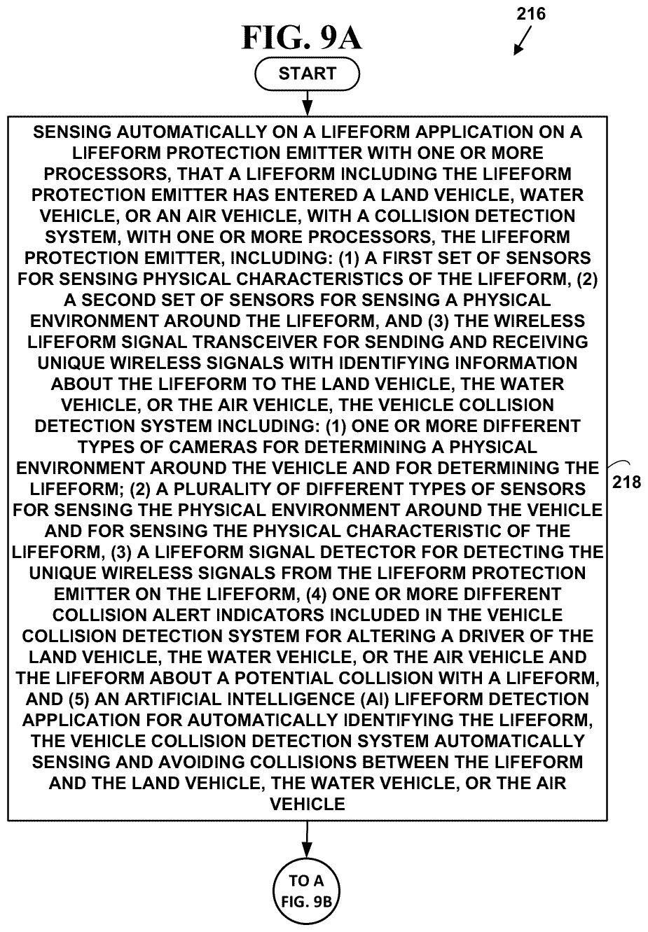

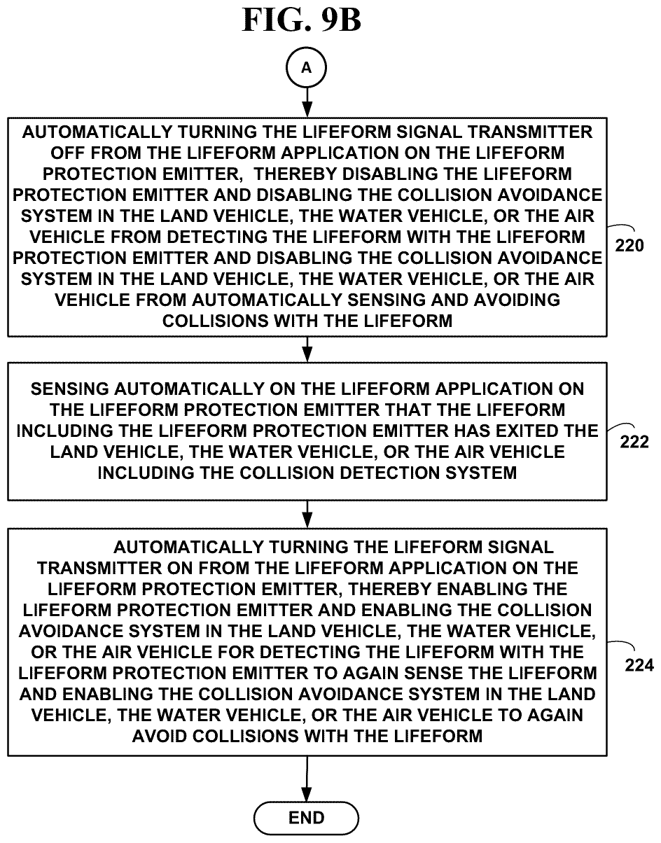

FIGS. 9A and 9B a flow diagram illustrating a Method 216 for enabling and disabling a lifeform protection.

In FIG. 9A at Step 218, sensing automatically on a lifeform application on a lifeform protection emitter with one or more processors, that a lifeform including the lifeform protection emitter has entered a land vehicle, water vehicle, or an air vehicle, with a collision detection system, with one or more processors, the lifeform protection emitter, including: (1) a first set of sensors for sensing physical characteristics of the lifeform, (2) a second set of sensors for sensing a physical environment around the lifeform, and (3) the wireless lifeform signal transceiver for sending and receiving unique wireless signals with identifying information about the lifeform to the land vehicle, the water vehicle, or the air vehicle, the vehicle collision detection system including: (1) one or more different types of cameras for determining a physical environment around the vehicle and for determining the lifeform; (2) a plurality of different types of sensors for sensing the physical environment around the vehicle and for sensing the physical characteristic of the lifeform, (3) a lifeform signal detector for detecting the unique wireless signals from the lifeform protection emitter on the lifeform, (4) one or more different collision alert indicators included in the vehicle collision detection system for altering a driver of the land vehicle, the water vehicle, or the air vehicle and the lifeform about a potential collision with a lifeform, and (5) an artificial intelligence (AI) lifeform detection application for automatically identifying the lifeform, the vehicle collision detection system automatically sensing and avoiding collisions between the lifeform and the land vehicle, the water vehicle, or the air vehicle; In FIG. 9B at Step 220, automatically turning the lifeform signal transmitter off from the lifeform application on the lifeform protection emitter, thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform; At Step 222, sensing automatically on the lifeform application on the lifeform protection emitter that the lifeform including the lifeform protection emitter has exited the land vehicle, the water vehicle, or the air vehicle including the collision detection system; and At Step 224, automatically turning the lifeform signal transmitter on from the lifeform application on the lifeform protection emitter, thereby enabling the lifeform protection emitter and enabling the collision avoidance system in the land vehicle, the water vehicle, or the air vehicle for detecting the lifeform with the lifeform protection emitter to again sense the lifeform and enabling the collision avoidance system in the land vehicle, the water vehicle, or the air vehicle, again avoiding collisions with the lifeform.

Method 216 is illustrated with a preferred embodiment. However, the present invention is not limited to such a preferred embodiment, and other embodiments can be used to practice the invention.

In such a preferred embodiment, In FIG. 9A at Step 218, sensing automatically on a lifeform application 44, 54 on a lifeform protection emitter 18, 20 with one or more processors, that a lifeform 24, 30, 32 including the lifeform protection emitter 18, 20 has entered a land vehicle 14, 28, 64, water vehicle 68, or an air vehicle 60, with a collision detection system 15, with one or more processors, the lifeform protection emitter 18, 20, including: (1) a first set of sensors 40, 50 for sensing physical characteristics of the lifeform 24, 30, 32, (2) a second set of sensors 42, 45, 52 for sensing a physical environment around the lifeform 24, 30, 32, and (3) a lifeform signal transceiver 49, 55 for sending and receiving unique wireless signals with identifying information about the lifeform 24, 30, 32 to the vehicle collision detection system 15 in the land vehicle 14, 28, 64, the water vehicle 68, or the air vehicle 60, the vehicle collision detection system 15, including: (1) one or more different types of cameras 71 for determining a physical environment around the vehicle and for determining the lifeform 24, 30, 32; (2) a plurality of different types of sensors 73 for sensing the physical environment around the land vehicle 14, 28, 64, the water vehicle 68, or the air vehicle 60 and for sensing the physical characteristic of the lifeform 24, 30, 32, (3) a lifeform signal detector 12, 75 for detecting the unique wireless signals from the lifeform signal transceiver 49, 55 on the lifeform 24, 30, 32 and the vehicle collision detection system 15 automatically sensing and avoiding collisions between the lifeform 24, 30, 32 and the land vehicle 14, 28, 64, the water vehicle 68, or the air vehicle 60, (4) one or more different collision alert indicators 87 included in the vehicle collision detection system 15 for altering a driver of the land vehicle 14, 28, 64, the water vehicle 68, or the air vehicle 60 and the lifeform 24, 30, 32 about a potential collision with a lifeform 24, 30, 32, and (5) an artificial intelligence (AI) lifeform detection application 19′ for automatically identifying the lifeform 24, 30, 32, the vehicle collision detection system automatically sensing and avoiding collisions between the lifeform 24, 30, 32 and the land vehicle 14, 28, 64, the water vehicle 68, or the air vehicle 60.

In one embodiment, lifeform signal transceiver 49, 55 and the lifeform signal detector 12, 75 include one or more of a: AM radio, FM radio, satellite radio, cellular telephone, 802.11a, 802.11b, 802.11g, 802.11n, 802.15.4 (ZigBee), Wireless Fidelity (Wi-Fi), Wi-Fi Aware, Worldwide Interoperability for Microwave Access (WiMAX), ETSI High Performance Radio Metropolitan Area Network (HIPERMAN), Near Field Communications (NFC), Machine-to-Machine (M2M), BLUETOOTH, Radio Frequency Identifier (RFID), infrared, satellite, aviation, marine, or a combination thereof, wireless signal transceivers and wireless signal detectors. However, the present invention is not limited to this embodiment and other embodiments can be used to practice the invention.

In one embodiment, the one or more different collision alert indicators 87 in the of the land vehicle 14, 28, 64, the water vehicle 68, or the air vehicle 60 include visual alert indictors (e.g., flashing lights, etc.), audio alert indicators (e.g., a horn, whistle, voice announcement, etc.), a control system alert indicator (e.g., automatic braking, automatic speed control, etc.) and/or a wireless transmitter to transmit wireless alert signals to the lifeform signal transceiver 49, 55 on the lifeform 24, 30, 32. In one embodiment, the wireless alert signals, include, but are not limited to, wireless alert signals including an audio sound such as an alarm sound (e.g., a beep, etc.), a voice announcement (e.g., say “watch out,” etc.) and/or generation of a vibration, etc. and/or a combination thereof. However, the present invention is not limited to this embodiment, and more, fewer and other types of different collision alert indicators 87 can be used to practice the invention.

In one embodiment, the unique wireless signals sent from the lifeform protection emitter include, but are not limited to, electronic information comprising: a unique hardware address (e.g., a Medium Access Control (MAC) address), network address (e.g., Internet Protocol (IP) address, etc.), phone number, user name, unique network identifier (e.g., Globally Unique Identifier (GUID), Universally Unique Identifier (UUID), encrypted token, stored contact, database record and/or cloud database record, email address, social media identifier, etc.) to uniquely identify the lifeform protection emitter 18, 20 and/or the lifeform 20, 34, 34. However, the present invention is not limited to this embodiment and other embodiments can be used to practice the invention.

A cloud computing network is also referred to as a “cloud communications network”. However, the present invention is not limited to this cloud computing model and other cloud computing models can also be used to practice the invention. The exemplary cloud communications network includes both wired and/or wireless components of public and private networks.

In one embodiment, the cloud computing network includes a cloud communications network comprising plural different cloud component networks. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

This exemplary cloud computing model for electronic information retrieval promotes availability for shared resources and comprises: (1) cloud computing essential characteristics; (2) cloud computing service models; and (3) cloud computing deployment models. However, the present invention is not limited to this cloud computing model and other cloud computing models can also be used to practice the invention.

Cloud software for electronic content retrieval takes full advantage of the cloud paradigm by being service oriented with a focus on statelessness, low coupling, modularity, and semantic interoperability for electronic content retrieval. However, cloud software services can include various states.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

In one exemplary embodiment, the applications 19, 19′ 82, offers cloud services for automatic digital document security processing and display system services. The application 19, 19′ offers the cloud computing Infrastructure as a Service (IaaS), including a cloud software infrastructure service, the cloud Platform as a Service (PaaS) including a cloud software platform service and/or offers Specific cloud software services as a Service (SaaS) including a specific cloud software service for automatic lifeform 24, 30, 32 identification processing and display system services. The IaaS, PaaS and SaaS include one or more of cloud services comprising networking, storage, server network device, virtualization, operating system, middleware, run-time, data and/or application services, or plural combinations thereof, on the cloud communications network.

In one embodiment, the one or more collision alert indicators include, but are not limited to, visual alert indicators, audio indicators and/or control system indicators. The visual collision alert indicators, include but are not limited to, one or more visual alert indicators, on a heads-up-display (HUD) on dashboard of a land vehicle 14, 28, 64 and/or control panel of the water vehicle 68 or the air vehicle 60, include but are not limited to, a flashing light indicator on dashboard of a land vehicle 14, 28, 64 and/or control panel of the water vehicle 68 or the air vehicle 60, the audio indicators include but are not limited to, a horn, etc. and the control system indicators, include but are not limited to, automatic engaging of a braking system, power system, transmission system, etc. on the land vehicle 14, 28, 64, water vehicle 68 or air vehicle 60, sending a visual and/or audio message and/or other alert on an external network device 17 and/other collision avoidance alert indicators. However, the present invention is not limited to such embodiments and other embodiments may be used to practice the invention.

In one embodiment, the one or more collision alert indicators may be added to and/or use components of an existing collection detection system already included on the land vehicle 14, 28, 64, water vehicle 68 or air vehicle 60. For example, most land vehicles 14, 28, 64, water vehicles 68 or air vehicles 60, already have existing collection detection systems.

In one embodiment, the lifeform application 44, 54 on the lifeform protection emitter 18, 20 automatically senses the lifeform 24, 30, 32 is inside the land vehicle 14, 28, 64, water vehicle 68 or air vehicle 60 using the first set of sensors 40, 50 that automatically sense vitals of the lifeform 24, 30, 32 including biometrics such as body temperature, blood pressure, heartbeat, pulse, oxygen consumption, respiration rate, etc. 42, 50 and/or equivalent of the lifeform 24, 30, 32 from the first set of sensors 40, 50 lifeform protection emitter 18, 20. However, the present invention is not limited to such embodiments and other embodiments may be used to practice the invention.

For example, the lifeform 24, 30, 32 may enter the land vehicle 14, 28, 64, water vehicle 68 or air vehicle 60 that is a different temperature (e.g., warmer, colder, etc.) from an outside environment require physical exertion (e.g., walking up/down a boarding ramp, boarding stairs, grabbing and closing a vehicle door, etc.) so the lifeform application 44, 54 on the lifeform protection emitter 18, 20 automatically senses changes in biometrics such as body temperature, blood pressure, heartbeat, pulse, respiration rate, oxygen consumption, etc. 42, 50 and/or equivalent of the lifeform 24, 30, 32 from the first set of sensors 40, 50 lifeform protection emitter 18, 20. However, the present invention is not limited to such embodiments and other embodiments may be used to practice the invention.

In one embodiment, the lifeform application 44, 54 on the lifeform protection emitter 18, 20 automatically senses the lifeform 24, 30, 32 is inside the land vehicle 14, 28, 64, water vehicle 68 or air vehicle 60 using the second set of sensors 42, 45, 52, including, but not limited to, a light sensor component, air pressure component, an altimeter component, a speed component, a pace component, a position component (X,Y,Z), a velocity component, an acceleration component, GPS component 40, 52 and/or a combination thereof, 45 (FIG. 4A) included on the lifeform protection emitter 18, 20. However, the present invention is not limited to such embodiments and other embodiments may be used to practice the invention.

In one embodiment, the light sensor component measures, illuminance, responds to changes in an amount of light received and/or includes an infrared light sensor to detect the movement of people or objects via infrared radiation being emitted. The position component includes determining a place for an object including its place on a X, Y and Z axis. The altimeter component measures a position of an object above a fixed level. The speed component includes measuring a rate of change of position of an object in any direction. The pace component includes a measuring a unit of length including a speed at which something happens with an object. The velocity component includes measuring a vector measurement of a rate and direction of motion of an object. The acceleration component includes measuring a rate at which a velocity of an object changes with time, in terms of both speed and direction. The GPS component measures latitude, longitude, and altitude of an object over time. However, the present invention is not limited to such embodiments and other embodiments may be used to practice the invention.

For example, if the lifeform 24, 30, 32 (e.g., the animal or human) enters a land vehicle 14, 28, 64 such as a car, truck bus, train, etc. there will be a difference in light, air pressure and/or elevation, between an outside environment and an inside environment inside the car, truck bus, train, 14, 28, 64 etc. There will also be a large difference in a physical location (e.g., GPS coordinates), velocity and/or speed component, acceleration component and/or pace component (e.g., counting steps then no steps for sitting, etc.) for the lifeform 24, 30, 32. For example, if the land vehicle 14, 28, 64 staring from a standing stop is now traveling 60 miles an hour, no lifeform 24, 30, 32 could achieve a velocity and/or acceleration, etc. and travel that fast without being in the land vehicle 14, 28, 64, etc. Therefore, the lifeform 24, 30, 32 is detected as being within the land vehicle 14, 28, 64 by the lifeform application 44, 54 on the lifeform protection emitter 18, 20. The same analysis applies to the water vehicles 68 and/or air vehicles 60. However, the present invention is not limited to such embodiments and other embodiments may be used to practice the invention.

In one embodiment, the lifeform includes, but is not limited to, a human 30, 32 and/or an animal 24 lifeform (e.g., dog, cat, livestock, bird, wild animals (e.g., deer, birds, etc.). In another embodiment, the lifeform includes a non-living object that is tracked including moveable object with the lifeform protection emitter 18, 20 (e.g., a package, box, container, etc.) and/or another type of movable objects that carried by a human and/or animal, including an AIR TAG by APPLE, Inc., a LIFE 360 TILE, Inc. from carried in a pocket, in a backpack, etc. In such embodiments, the other type of movable object is tracked using it's specific wireless signals as the lifeform 24, 30, 32 moves around. However, the present invention is not limited to such embodiments and other embodiments may be used to practice the invention.

In one embodiment, the lifeform protection emitter 18, 20 includes, but is not limited to, an electronic fitness watch, medical device (e.g., medical sensor for blood sugar, etc.), electronic fitness bracelet, electronic medical bracelet, wearable network device, smart phone 17 and/or electronic tablet, and/or other lifeform protection emitter 18, 20. However, the present invention is not limited to such embodiments and other embodiments may be used to practice the invention.

In one embodiment, the land vehicle 14, 28, 64, includes, but is not limited to, an automobile, truck, bus, locomotive, farm vehicle (e.g., combine, tractor, etc.) construction vehicle (e.g., bull dozer, crane, backhoe, etc.), bicycle, motorcycle and/or sports vehicle (e.g., snowmobile, all-terrain vehicle (ATV), three-wheeler, four-wheeler, side-by-side, etc.) and other types of land vehicles. However, the present invention is not limited to such embodiments and other embodiments may be used to practice the invention.

In one embodiment, the air vehicle 60, includes, but is not limited to, an air vehicle includes: an airplane, helicopter, unmanned aerial vehicle (UAV), drone, and/or airship and/or other types of air vehicles. However, the present invention is not limited to such embodiments and other embodiments may be used to practice the invention. However, the present invention is not limited to such embodiments and other embodiments may be used to practice the invention.

In one embodiment the water vehicle 68, includes but is not limited to, water vehicle includes: boat, ship, personal watercraft (PWC), canoe, raft, and/or kayak and/or other types of water vehicles. However, the present invention is not limited to such embodiments and other embodiments may be used to practice the invention.

In one embodiment, the first set of sensors 40, 50, 45 for sensing physical characteristics of the lifeform 24, 30, 32 include but are not limited to, a plurality of sensors for sensing lifeform vitals of the lifeform including lifeform 24, 30, 32 biometrics comprising: body temperature, blood pressure, heartbeat, pulse, respiration rate, and/or oxygen consumption and/or a combination 45 thereof. However, the present invention is not limited to such embodiments and other embodiments may be used to practice the invention.

In one embodiment, the second set of sensors 42, 45, 52 for sensing a physical environment around the lifeform 24, 30, 32 includes, but is not limited to, a plurality of sensors comprising: a light sensor component, air pressure component, an altimeter component, a speed component, a pace component, a position component (X,Y,Z), a velocity component, an acceleration component, a Global Positioning System (GPS) component, and/or a combination 45 thereof. However, the present invention is not limited to such embodiments and other embodiments may be used to practice the invention.

In one embodiment, the one or more different types of cameras 71 include visual cameras, thermal imaging cameras, and/or acoustic imaging cameras and/or a combination thereof. However, the present invention is not limited to such embodiments and other embodiments may be used to practice the invention.

In one embodiment, a visual camera captures visual images of an object. A thermal imaging camera captures a temperature of an object and displays it as a visual image. An acoustic imaging camera is an imaging device used to locate and characterize sound sources generated by objects. However, the present invention is not limited to such embodiments and other embodiments may be used to practice the invention.

In one embodiment, the visual camera includes a facial recognition application to accurately identify a human lifeform 30, 32. However, the present invention is not limited to such embodiments and other embodiments without a facial recognition application may be used to practice the invention.

In one embodiment, the plurality of different types of sensors 73 for sensing the physical environment around the and for sensing the physical characteristic of the lifeform 24, 30, 32, include a plurality of sensors comprising: light sensor component, air pressure component, an altimeter component, a speed component, a position component (X,Y,Z), a velocity component, an acceleration component, a Global Positioning System (GPS) component, radar component, includes Light Detection And Ranging (LiDAR) component, Light Detection and Ranging (LADAR) component, sonar component and/or a combination thereof. However, the present invention is not limited to such embodiments and other embodiments may be used to practice the invention.

In one embodiment, the radar component includes a device that sends out radio waves for detecting and locating an object by the reflection of the radio waves using that reflection to find out a position and speed of the object. The Light Detection And Ranging (LiDAR) component includes a laser-based remote sensing technology that points a small laser at an object and measures a time it takes the laser to return to its source. The Light Detection and Ranging (LADAR) component, is a remote sensing technology that uses a laser to measure a distance to an object. The sonar component includes a method or device for detecting and locating objects by sending out sound waves towards and object and have the sound waves rejected back by the object. However, the present invention is not limited to such embodiments and other embodiments may be used to practice the invention

In one embodiment, the wireless signal transmitter 49, 55 on the lifeform protection emitter 18, 20 and the wireless signal detector 12, 75 on the collision avoidance system 15 in the land vehicle 14, 28, 64, the water vehicle 68, or the air vehicle 68 include one or more of a: AM radio, FM radio, satellite radio, cellular telephone, 802.11a, 802.11b, 802.11g, 802.11n, 802.15.4 (ZigBee), Wireless Fidelity (Wi-Fi), Wi-Fi Aware, RF Home, Worldwide Interoperability for Microwave Access (WiMAX), ETSI High Performance Radio Metropolitan Area Network (HIPERMAN), Near Field Communications (NFC), Machine-to-Machine (M2M), BLUETOOTH, RFID, infrared, aviation band, satellite band, or marine band and/or a combination thereof, wireless signal transmitters 49, 55 and/or wireless signal detectors 12, 75. However, the present invention is not limited to such embodiments and other embodiments with other types of wireless signals and wireless interfaces may be used to practice the invention.

“Artificial intelligence” (AI), also known as machine intelligence (MI), is intelligence demonstrated by machines, in contrast to the natural intelligence (NI) displayed by humans and other animals. AI research is defined as the study of “intelligent agents.” Intelligent agents are any software application or hardware device that perceives its environment and takes actions that maximize its chance of successfully achieving its goals. Colloquially, the term “artificial intelligence” is applied when a machine mimics “cognitive” functions that humans associate with human brains, such as learning, problem solving and comparing large number of data points.

In one embodiment, the present invention uses one or more AI methods including, but are not limited to, AI knowledge-based methods for one or more AI methods for: human facial recognition, human shape form recognition, animal shape form recognition; human sound recognition, animal sound recognition, human biometrics (e.g., body temperature, blood pressure, heartbeat, pulse, respiration rate, oxygen consumption, etc.) recognition and analysis and/or animal biometrics (e.g., body temperature, blood pressure, heartbeat, pulse, respiration rate and/o oxygen consumption, etc.) recognition and analysis. The AI knowledge-based methods include, but are not limited to, AI knowledge-based methods for determining car-jacking or vehicle theft events and responses, repossession events and responses, rental car rental and rental car return events and responses and/or a precise geographical location with GPS and a precise date and/Or time of such events and responses. However, the present invention is not limited to such an embodiment and more, fewer and/or other AI methods can be used to practice the invention.

In one embodiment, SaaS cloud software application includes and AI application with the AI methods described herein. In another embodiment, the AI application is a standalone application. However, the present invention is not limited to such an embodiment, and the AI application can be provided in other than the SaaS.

“Big Data” refers to the use of predictive analytic methods that extract value from data, and to a particular size of data set. The quantities of data used are very large, at least 100,000 data points and more typically 500,000 to 1 Million+ data points. Analysis of Big Data sets are used to find new correlations and to spot trends. In one embodiment, SaaS includes and Big Data application with the Big Data described herein.

In one embodiment, the artificial intelligence (AI) lifeform detection application 19′ includes, but is not limited to, one or more AI methods for: human facial recognition, human shape form recognition, animal shape form recognition; human sound recognition, animal sound recognition, human biometrics (e.g., body temperature, blood pressure, heartbeat, pulse, respiration rate, oxygen consumption, etc.) recognition and analysis, animal biometrics (e.g., body temperature, blood pressure, heartbeat, pulse, respiration rate, oxygen consumption, etc.) recognition and analysis; and/or other AI methods using (1) the one or more different types of cameras 71 for determining a physical environment around the vehicle and for determining the lifeform 24, 30, 32; (2) a plurality of different types of sensors 73 for sensing the physical environment around the vehicle and for sensing the physical characteristic of the lifeform, (3) a lifeform signal detector 12, 75 for detecting the unique wireless signals from the lifeform protection emitter 18, 20 on the lifeform 24, 30, 32. However, the present invention is not limited to such embodiments and other embodiments with other types of wireless signals and wireless interfaces may be used to practice the invention.

In one embodiment, the lifeform application 19 on the external network device 17, includes, but is not limited to, the artificial intelligence (AI) lifeform detection application 19′. However, the present invention is not limited to such embodiments and other embodiments may be used to practice the invention

In one embodiment, Amplitude Modulation (AM) radio wireless signals include a range 535 kilohertz (kHz) to 1605 kHz where wave amplitude varies and frequency is constant. Frequency Modulation (FM) radio signals include a range of 88 megahertz (MHz) to 108 MHz in this kind of wave frequency varies while the amplitude is constant. Satellite radio wireless signals are divided into different bands including L-band, S-band, C-band, X-band, Ku-band, and Ka-band, with each band having its own specific frequency range and application in satellite communication. Satellite radio signals in the United States include a 2.3 gigahertz (GHz) S-band of signal, while elsewhere on the earth, it often uses the 1.4 GHz L-band. However, the present invention is not limited to such embodiments and other embodiments may be used to practice the invention.

The 802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54 Mbps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

Wi-Fi is a type of 802.11xx interface, whether 802.11b, 802.11a, dual-band, etc. Wi-Fi devices include an Radio Frequency (RF) interfaces such as 2.4 GHz for 802.11b or 802.11g and 5 GHz for 802.11a.

In 802.11 wireless networking standards (including Wi-Fi), a service set is a group of wireless network devices that share a Service Set IDentifier (SSID) and is typically a natural language label (e.g., Radu's Home Network, etc.) that users see as a network name. For example, all of the network devices that together form and use a Wi-Fi network called Radu's Home Network are a service set. A service set forms a logical network of nodes operating with shared link-layer networking parameters; they form one logical network segment.

A service set is either a basic service set (BSS) or an extended service set (ESS). A basic service set is a subgroup, within a service set, of devices that share physical-layer medium access characteristics (e.g. radio frequency, modulation scheme, security settings, etc.) such that they are wirelessly networked. The basic service set is defined by a basic service set identifier (BSSID) shared by all devices within it. The BSSID includes a 48-bit label that conform to MAC-48 conventions. While a network device may have multiple BSSIDs, usually each BSSID is associated with at most one basic service set at a time.

802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, a full handshake protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

Wi-Fi, is a family of wireless network protocols, based on the IEEE 802.11 family of standards, which are commonly used for local area networking of devices and Internet access, allowing nearby digital devices to exchange data by radio waves. These are the most widely used computer networks in the world, used globally in home and small office networks to link desktop and laptop computers, tablet computers, smartphones, smart TVs, printers, and smart speakers together and to a wireless router to connect them to the Internet, and in wireless access points in public places like coffee shops, hotels, libraries and airports to provide the public Internet access for mobile devices.

Wi-Fi Aware devices continuously discover other devices within a user's Wi-Fi range, making it easy to find nearby information and services that match preferences set by the user.

Near field communication (NFC)” is a set of standards for smartphones and similar network devices to establish radio communication with each other by touching them together or bringing them into close proximity, usually no more than a few centimeters. Present applications include contactless transactions, data exchange, and simplified setup of more complex communications such as Wi-Fi. Communication is also possible between an NFC device and an unpowered NFC chip, called a “tag” including radio frequency identifier (RFID) tags 99 and/or sensor.

NFC standards cover communications protocols and data exchange formats, and are based on existing radio-frequency identification (RFID) standards including ISO/IEC 14443 and FeliCa. These standards include ISO/IEC 1809 and those defined by the NFC Forum, all of which are incorporated by reference.

An “RFID tag” is an object that can be applied to or incorporated into a product, animal, or person for the purpose of identification and/or tracking using RF signals.

An “RFID sensor” is a device that measures a physical quantity and converts it into an RF signal which can be read by an observer or by an instrument.

“Machine to machine (M2M)” refers to technologies that allow both wireless and wired systems to communicate with other devices of the same ability. M2M uses a device to capture an event (such as option purchase, etc.), which is relayed through a network (wireless, wired cloud, etc.) to an application (software program), that translates the captured event into meaningful information. Such communication was originally accomplished by having a remote network of machines relay information back to a central hub for analysis, which would then be rerouted into a system like a personal computer.

However, modern M2M communication has expanded beyond a one-to-one connection and changed into a system of networks that transmits data many-to-one and many-to-many to plural different types of devices and appliances. The expansion of IP networks across the world has made it far easier for M2M communication to take place and has lessened the amount of power and time necessary for information to be communicated between machines.

BLUETOOTH operates in the 2.4 gigahertz (GHz) Industrial, Scientific, and Medical (ISM) band at 2400-2483.5 megahertz (MHz). It uses 40 radio frequency (RF) channels (each channel is 2 MHz wide). The ISM frequency bands are a group RF bands set aside for industrial, scientific, and medical uses. Infrared wireless signals detect infrared (IR) light that has wavelengths λ between 780 nanometer (nm) and 1 millimeter (mm), which corresponds to a frequency range from 300 GHz to 400 terahertz (THz). The Infrared Data Association (IrDA) standard operation requires a device frequency of 3.6864 MHz.

In one embodiment, the aviation wireless signals include a group of frequencies in a VHF radio spectrum used for aviation radio communication. The band is typically between about 108 and 137 MHz. The satellite wireless signals include a microwave spectrum, typically spanning from about 1 GHz to around 40 GHz and is divided into different bands like L-band, S-band, C-band, X-band, Ku-band, and Ka-band, with each band having its own specific frequency range and application in satellite communication. The marine wireless signals include FM channels in the VHF radio band in the frequency range between 156 and 174 MHz.

Returning to FIG. 9, in FIG. 9B at Step 220, automatically turning the lifeform signal transmitter 49, 55 off from the lifeform application 44, 54 on the lifeform protection emitter 18, 20, thereby disabling the lifeform protection emitter 18, 20 and disabling the collision avoidance system 15 in the land vehicle 14, 28, 64, the water vehicle 68, and/or the air vehicle 60 from detecting the lifeform 24, 30, 32 with the lifeform protection emitter 18, 20 and disabling the collision avoidance system 15 in the land vehicle 14 28, 64, the water vehicle 68, and/or the air vehicle 60 from automatically sensing and avoiding collisions with the lifeform 24, 30, 32.

At Step 222, sensing automatically on the lifeform application 44, 54 on the lifeform protection emitter 18, 20, that the lifeform 24, 30, 32 including the lifeform protection emitter 18, 20 has exited the land vehicle 14, 28, 34, the water vehicle 68, or the air vehicle 60 with the collision detection system 15.

In one embodiment, the lifeform protection emitter 18, 20 automatically senses the lifeform 24, 30, 32 has exited and is outside the land vehicle 14, 28, 64, water vehicle 68 and/or air vehicle 60 using a light sensor component, air pressure component, an altimeter component, a speed component, a pace component, a velocity component, an acceleration component (from the GPS component 40, 52) and/or a combination thereof, 45 (FIG. 4A) included on the lifeform protection emitter 18, 20. However, the present invention is not limited to such embodiments and other embodiments may be used to practice the invention.

For example, if the lifeform 24, 30, 32 including animal or human exists a land vehicle such as a car, truck bus, train, etc. there will be a difference in light, air pressure and/or elevation, between an inside environment inside the car, truck bus, train, etc. and an outside environment. There will also be a large difference in a speed component and/or pace component for the lifeform 24, 30, 32. For example, if the land vehicle was traveling 60 miles an hour and is now fully stopped, no lifeform 24, 30, 32 could achieve such a change in speed, pace, velocity, acceleration, etc., without being in a vehicle, etc. However, the present invention is not limited to such embodiments and other embodiments may be used to practice the invention.

At Step 224, automatically turning the lifeform signal transmitter 49, 55 on from the lifeform application 44, 54 on the lifeform protection emitter 18, 20, thereby enabling the lifeform protection emitter 49, 55 and enabling the collision avoidance system 15 in the land vehicle, the water vehicle 68, or the air vehicle 60 for detecting the lifeform 24, 30, 32 with the lifeform protection emitter 18, 20 thereby enabling the lifeform protection emitter 18, 20 and enabling the collision avoidance system 15 in the land vehicle 14, 28, 64, the water vehicle 60, or the air vehicle 68 for detecting the lifeform 24, 30, 32 with the lifeform protection emitter 18, 20 to again sense the lifeform 24, 30, 32 and enabling the collision avoidance system 15 in the land vehicle 14, 28, 64, the water vehicle 60, or the air vehicle 68, again avoiding collisions with the lifeform 24, 30, 32.

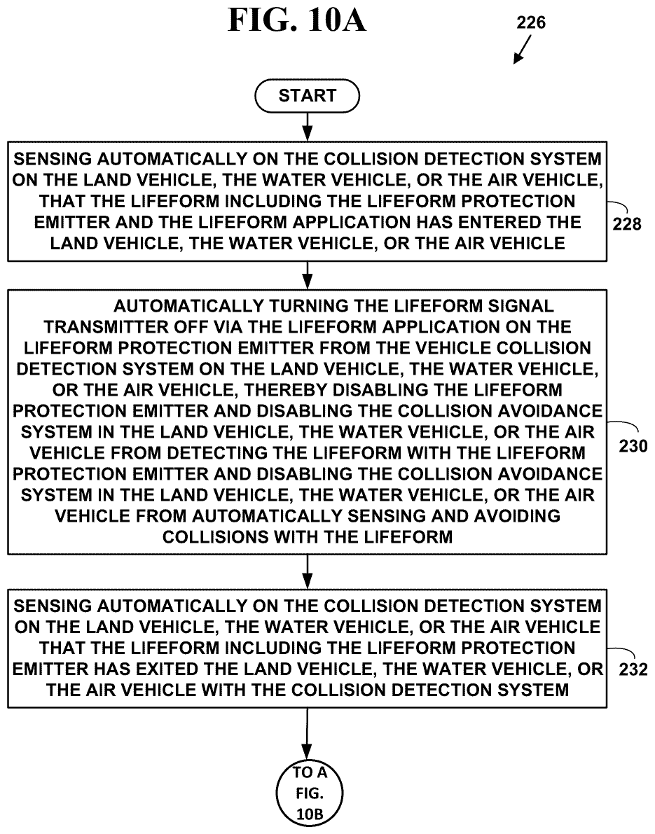

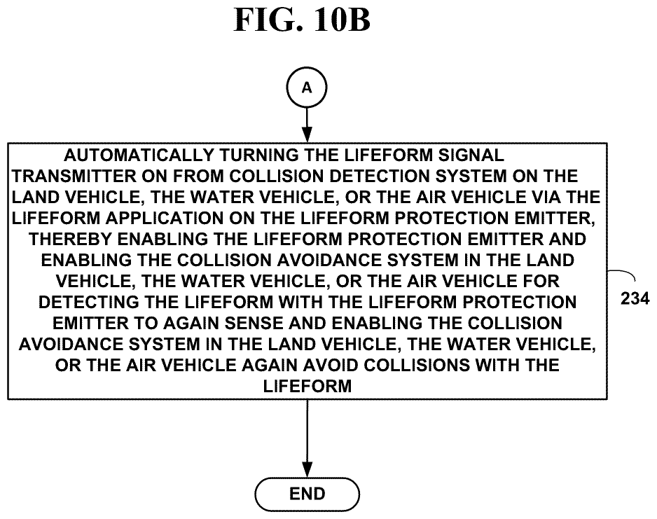

FIGS. 10A and 10B are a flow diagram illustrating a Method 226 for enabling and disabling a lifeform protection emitter 18, 20.

In FIG. 10A at Step 228, sensing automatically on the collision detection system on the land vehicle, the water vehicle, or the air vehicle, that the lifeform including the lifeform protection emitter and the lifeform application has entered the land vehicle, the water vehicle, or the air vehicle; at Step 230 automatically turning the lifeform signal transmitter off via the lifeform application on the lifeform protection emitter from the vehicle collision detection system on the land vehicle, the water vehicle, or the air vehicle, thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform; at Step 232, sensing automatically on the collision detection system on the land vehicle, the water vehicle, or the air vehicle that the lifeform including the lifeform protection emitter has exited the land vehicle, the water vehicle, or the air vehicle with the collision detection system; and In FIG. 10B at Step 234, automatically turning the lifeform signal transmitter on from collision detection system on the land vehicle, the water vehicle, or the air vehicle via the lifeform application on the lifeform protection emitter, thereby enabling the lifeform protection emitter and enabling the collision avoidance system in the land vehicle, the water vehicle, or the air vehicle for detecting the lifeform with the lifeform protection emitter to again sense and enabling the collision avoidance system in the land vehicle, the water vehicle, or the air vehicle again avoid collisions with the lifeform.

Method 226 is illustrated with a preferred embodiment. However, the present invention is not limited to such a preferred embodiment, and other embodiments can be used to practice the invention.

In such a preferred embodiment, In FIG. 10 at Step 228, sensing automatically on the collision detection system 15 on the land vehicle, 14, 28, 64 the water vehicle 68, or the air vehicle 60, that the lifeform 24, 30, 32 including the lifeform protection emitter 18, 20 and the lifeform application 44, 54 has entered the land vehicle 14, 28, 64, the water vehicle 68, or the air vehicle 60.

At Step 230 automatically turning the lifeform signal transmitter 49, 55 off via the lifeform application 44, 54 on the lifeform protection emitter 18, 20 from the vehicle collision detection system 15 on the land vehicle 14, 28, 64, the water vehicle 68, or the air vehicle 60, thereby disabling the lifeform protection emitter 18, 20 and disabling the collision avoidance system 15 in the land vehicle 14, 28, 64, the water vehicle 68, or the air vehicle 60 from detecting the lifeform 24, 30, 32 with the lifeform protection emitter 18, 20 and disabling the collision avoidance system 15 in the land vehicle 14, 28, 64, the water vehicle 68, or the air vehicle 60 from automatically sensing and avoiding collisions with the lifeform 24, 30, 42.

In one embodiment, the collision detection system 15 in the land vehicle 14, 28, 64, water vehicle 68 or air vehicle 60 automatically senses a physical location of the lifeform 24, 30, 32, by reading GPS information 40, 52 on the lifeform protection emitter 18, 20 and determining the lifeform protection emitter 18, 20 is at a same physical location as the land vehicle 14, 28, 64, water vehicle 68 or air vehicle 60 based on its own GPS information. However, the present invention is not limited to such embodiments and other embodiments may be used to practice the invention.

In another embodiment, the collision detection system 15 in the land vehicle 14, 28, 64, water vehicle 68 or air vehicle 60 automatically senses lifeform vitals of the lifeform 24, 30, 32 including biometrics such as body temperature, blood pressure, heartbeat, pulse, oxygen consumption, and/or respiration rate, etc. 42, 50 and/or equivalent of the lifeform 24, 30, 32 from the lifeform protection emitter 18, 20. However, the present invention is not limited to such embodiments and other embodiments may be used to practice the invention.

In another embodiment, the collision detection system 15 in the land vehicle 14, 28, 64, water vehicle 68 or air vehicle 60 automatically senses the lifeform 24, 30, 32 with one or more other different sensors in the land vehicle 14, 28, 64, water vehicle 68 or air vehicle 60, including but not limited to air bag seat sensors, seatbelt sensors, engine ignition sensors, etc. However, the present invention is not limited to such embodiments and other embodiments may be used to practice the invention.

In one embodiment, the air bag seat sensors activate an airbag circuit when a person of a certain weight sits in a seat of a vehicle 14, 28, 60, 64, 68. For example, an adult person sitting in a passenger seat in a land vehicle 14, 28, 64 activates a passenger side air bag that is not active if there is no passenger sitting in the passenger seat of the vehicle. However, the present invention is not limited to such embodiments and other embodiments may be used to practice the invention.

At Step 232, sensing automatically on the collision detection system 15 on the land vehicle 14, 28, 64 the water vehicle 68, or the air vehicle 60 that the lifeform 24, 30, 32 including the lifeform protection emitter 18, 20 has exited the land vehicle 14, 28, 64, the water vehicle 68, or the air vehicle 60 with the collision detection system 15.

In FIG. 10B at Step 234, automatically turning the lifeform signal transmitter 49, 55 on from collision detection system 15 on the land vehicle 14, 28, 64, the water vehicle 68, or the air vehicle 60 via the lifeform application 44, 54 on the lifeform protection emitter 18, 20, thereby enabling the lifeform protection emitter 18, 20 and enabling the collision avoidance system 15 in the land vehicle 14, 28, 64, the water vehicle 68, or the air vehicle 60 for detecting the lifeform 24, 30, 32 with the lifeform protection emitter 18, 20 to again sense and enabling the collision avoidance system 15 in the land vehicle 14, 28, 64, the water vehicle 68, or the air vehicle 60 again avoid collisions with the lifeform 24, 30, 32.

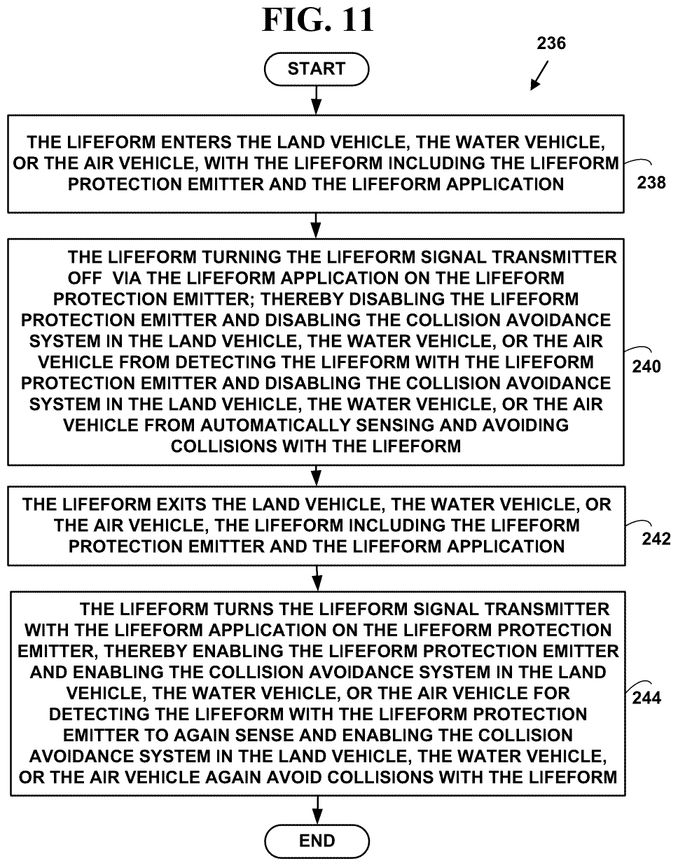

FIG. 11 is a flow diagram illustrating a Method 236 for enabling and disabling a lifeform protection emitter 18, 20.

In FIG. 11, At Step 238, the lifeform enters the land vehicle, the water vehicle, or the air vehicle including the lifeform protection emitter and the lifeform application; At Step 240, the lifeform turns the lifeform signal transmitter off via the with the lifeform application on the lifeform protection emitter; thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform; At Step 242, the lifeform exits the land vehicle, the water vehicle, or the air vehicle, the lifeform including the lifeform protection emitter and the lifeform application; and At Step 244, the lifeform turns the lifeform signal transmitter on via the lifeform with the lifeform application on the lifeform protection emitter, thereby enabling the lifeform protection emitter and enabling the collision avoidance system in the land vehicle, the water vehicle, or the air vehicle for detecting the lifeform with the lifeform protection emitter to again sense and enabling the collision avoidance system in the land vehicle, the water vehicle, or the air vehicle again avoid collisions with the lifeform.

Method 236 is illustrated with a preferred embodiment. However, the present invention is not limited to such a preferred embodiment, and other embodiments can be used to practice the invention.

In such a preferred embodiment, In FIG. 11 at Step 238, the lifeform 24, 30, 34 enters the land vehicle 14, 28, 64, the water vehicle 68, or the air vehicle 60 including the lifeform protection emitter 18, 20 and the lifeform application 44, 54.

At Step 240, the lifeform 30, 32 turns the lifeform signal transmitter 49, 55 off via the with the lifeform application 44, 54 on the lifeform protection emitter 18, 20; thereby disabling the lifeform protection emitter 49, 55 and disabling the collision avoidance system 15 in the land vehicle 14, 28, 64, the water vehicle 68, or the air vehicle 60 from detecting the lifeform 24, 30, 34 with the lifeform protection emitter 18 and disabling the collision avoidance system 15 in the land vehicle 14, 28, 64, the water vehicle 68, or the air vehicle 60 from automatically sensing and avoiding collisions with the lifeform 24, 30, 34.

In one embodiment, if the lifeform 24 is an animal, a human lifeform 30, 32, turns the lifeform protection emitter 20 for the animal lifeform 24.

In one embodiment, a second human lifeform 30, 32 turns the lifeform protection emitter 18 off, or the first lifeform 30, 32 turns the lifeform protection emitter 18, 20 off for the one or more life forms 24, 30, 32 with a manual switch 47 or via a menu item on the lifeform protection emitter 18, 20 and/o via on a lifeform application 44, 54 on the lifeform protection emitter 18, 20. However, the present invention is not limited to such embodiments and other embodiments may be used to practice the invention.

In one embodiment, the lifeform 30, 32 turns the lifeform protection emitter 18 off, or the first lifeform 30, 32 turns the lifeform protection emitter 18, 20 off for the one or more second life forms 24, 30, 32 via an external network device 17 (e.g., cell phone, electronic tablet, other wearable, laptop computer, etc.) with one or more processors and a lifeform detection application 19 connected to a communications network 21. In such an embodiment, the lifeform detection application 19 on the external network devices 17, turns the lifeform protection emitter 18, 20 on and off directly and/or turns the lifeform protection emitter 18, 20, on and off via the lifeform application 44, 54 on the lifeform protection emitter 18, 20. However, the present invention is not limited to such embodiments and other embodiments may be used to practice the invention.

At Step 242, the lifeform 24, 30, 32 exits the land vehicle 14, 28, 64, the water vehicle 68, or the air vehicle 60, the lifeform 24, 30, 32 including the lifeform protection emitter and the lifeform application 44, 54.

At Step 244, the lifeform 30, 32 turns the lifeform signal transmitter 49, 55 on via the lifeform 24, 30, 32 with the lifeform application 44, 54 on the lifeform protection emitter 18, 20, thereby enabling the lifeform protection emitter 18, 20 and enabling the collision avoidance system 15 in the land vehicle 14, 28, 64, the water vehicle 68, or the air vehicle 60 for detecting the lifeform 24, 30, 32 with the lifeform protection emitter 18, 20 to again sense and enabling the collision avoidance system 15 in the land vehicle 14, 28, 64, the water vehicle 68, or the air vehicle 60 and again avoid collisions with the lifeform 24, 30, 32.

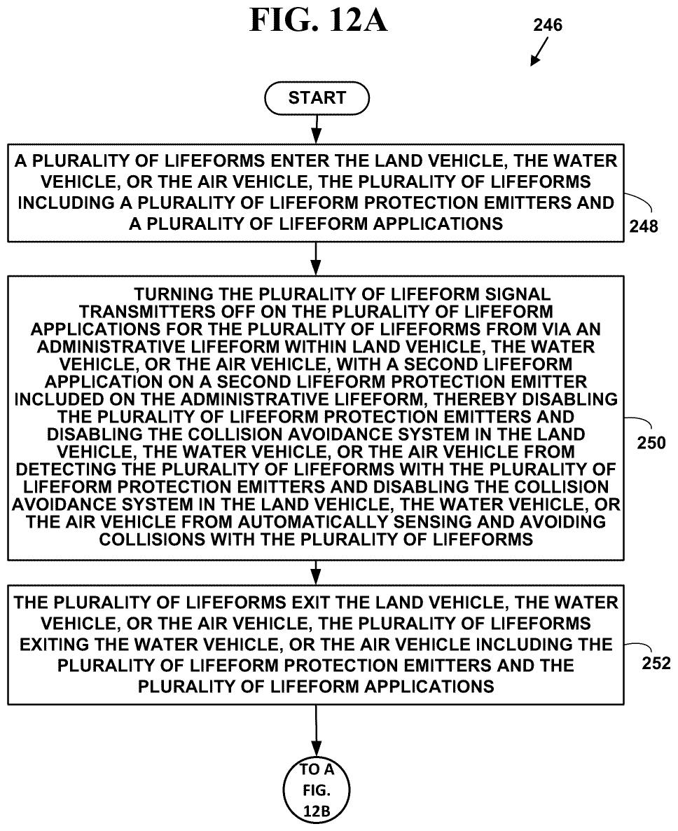

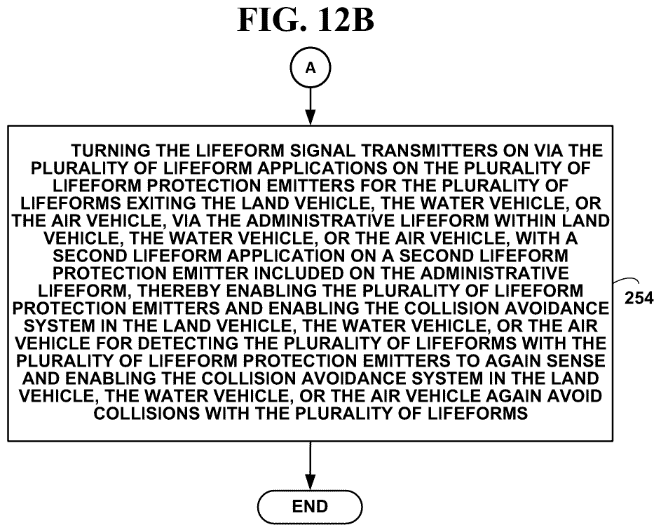

FIGS. 12A and 12B are a flow diagram illustrating a Method 246 for enabling and disabling a lifeform protection emitter.

In FIG. 12A, at Step 248, a plurality of lifeforms entering the land vehicle, the water vehicle, or the air vehicle, the plurality of lifeforms including a plurality of lifeform protection emitters and a plurality of lifeform applications; At Step 250, turning the plurality of lifeform signal transmitters off via the plurality of lifeform applications for the plurality of lifeforms from via an administrative lifeform within land vehicle, the water vehicle, or the air vehicle, with a second lifeform application on a second lifeform protection emitter included on the administrative lifeform, thereby disabling the plurality of lifeform protection emitters and disabling the collision avoidance system in the land vehicle, the water vehicle, or the air vehicle from detecting the plurality of lifeforms with the plurality of lifeform protection emitters and disabling the collision avoidance system in the land vehicle, the water vehicle, or the air vehicle from automatically sensing and avoiding collisions with the plurality of lifeforms; At Step 252, the plurality of lifeforms exiting the land vehicle, the water vehicle, or the air vehicle, the plurality of lifeforms exiting the water vehicle, or the air vehicle including the plurality of lifeform protection emitters and the plurality of lifeform applications; and in FIG. 12B At Step 254, turning the lifeform signal transmitters on via the plurality of lifeform applications on the plurality of lifeform protection emitters for the plurality of lifeforms exiting the land vehicle, the water vehicle, or the air vehicle, via the administrative lifeform within land vehicle, the water vehicle, or the air vehicle, with a second lifeform application on a second lifeform protection emitter included on the administrative lifeform, thereby enabling the plurality of lifeform protection emitters and enabling the collision avoidance system in the land vehicle, the water vehicle, or the air vehicle for detecting the plurality of lifeforms with the plurality of lifeform protection emitters to again sense and enabling the collision avoidance system in the land vehicle, the water vehicle, or the air vehicle again avoid collisions with the plurality of lifeforms.

Method 246 is illustrated with a preferred embodiment. However, the present invention is not limited to such a preferred embodiment, and other embodiments can be used to practice the invention.

In such a preferred embodiment, In FIG. 12A at Step 248, a plurality of lifeforms 24, 30, 32 entering the land vehicle 14, 28, 64, the water vehicle 68, or the air vehicle 60, the plurality of lifeforms 24, 30, 32 including a plurality of lifeform protection emitters 18, 20 and a plurality of lifeform applications 44, 54.

In one embodiment, the plurality of lifeforms 24, 30, 32 are entering a bus, airplane, boat, etc. However, the present invention is not limited to such a preferred embodiment, and other embodiments can be used to practice the invention.

At Step 250, turning the plurality of lifeform signal transmitters 49, 54 off via the plurality of lifeform applications 44, 54 for the plurality of lifeforms 24, 30, 32 from via an administrative lifeform 32′ within land vehicle, the water vehicle 68, or the air vehicle 60, with a second lifeform application 44′ (FIG. 1) on a second lifeform protection emitter 18′ included on the administrative lifeform 32′, thereby disabling the plurality of lifeform protection emitters 18, 20 and disabling the collision avoidance system 15 in the land vehicle 14, 28, 64, the water vehicle 68, or the air vehicle 60 from detecting the plurality of lifeforms 24, 30, 32 with the plurality of lifeform protection emitters 18, 20 and disabling the collision avoidance system 15 in the land vehicle 14, 28, 64, the water vehicle 68, or the air vehicle 60 from automatically sensing and avoiding collisions with the plurality of lifeforms 24, 30, 32.

At Step 252, the plurality of lifeforms 24, 30, 32 exiting the land vehicle 14, 28, 64, the water vehicle 68, or the air vehicle 60, the plurality of lifeforms 24, 30, 32, exiting the water vehicle 60, or the air vehicle 68 including the plurality of lifeform protection emitters 18, 20 and the plurality of lifeform applications 44, 54.

In FIG. 12B at Step 254, turning the lifeform signal transmitters 49, 55 on via the plurality of lifeform applications 44, 54 on the plurality of lifeform protection emitters 18, 20 for the plurality of lifeforms 24, 30, 32 exiting the land vehicle 14, 28, 64, the water vehicle 68, or the air vehicle 60, via the administrative lifeform 32′ within land vehicle 14, 28, 64, the water vehicle 68, or the air vehicle 60, with a second lifeform application 44′ on a second lifeform protection emitter 18′ included on the administrative lifeform 32′, thereby enabling the plurality of lifeform protection emitters 18, 20 and enabling the collision avoidance system 15 in the land vehicle 14, 28, 64, the water vehicle 68, or the air vehicle 60 for detecting the plurality of lifeforms 24, 30, 32 with the plurality of lifeform protection emitters 18, 20 to again sense and enabling the collision avoidance system 15 in the land vehicle 14, 28, 64, the water vehicle 68, or the air vehicle 60 again avoid collisions with the plurality of lifeforms 24, 30, 32.

In one embodiment, Method 246 further includes only selected ones of the plurality of lifeforms 24, 30, 32 exiting the land vehicle 14, 28, 64, the water vehicle 68, or the air vehicle 60; and turning the lifeform signal transmitters 18, 20 on for the selected ones of the plurality of lifeforms 24, 30, 32 exiting the land vehicle 14, 28, 64, the water vehicle 68, or the air vehicle 60, via the administrative lifeform 32′ within land vehicle 14, 28, 64, the water vehicle 68, or the air vehicle 60, with the second lifeform application 44′ on the second lifeform protection emitter 18′ included on the administrative lifeform 32′, thereby enabling the selected ones of the of lifeform protection emitters 18, 20 of the plurality of lifeforms 24, 30, 32 exiting the land vehicle 14, 28, 64, the water vehicle 68, or the air vehicle 60 and enabling the collision avoidance system 15 in the land vehicle 14, 28, 64, the water vehicle 68, or the air vehicle 60 for detecting the selected ones of the plurality of lifeforms 24, 30, 32 to again sense and enabling the collision avoidance system 15 in the land vehicle 14, 28, 64, the water vehicle 68, or the air vehicle 60 again avoid collisions with the selected ones of the plurality of lifeforms 24, 30, 32. However, the present invention is not limited to such a preferred embodiment, and other embodiments can be used to practice the invention.

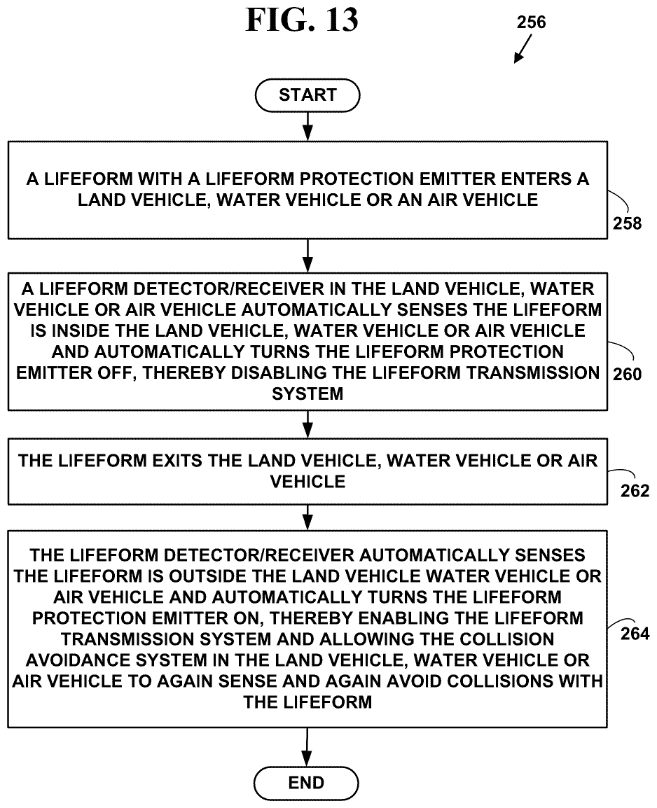

FIG. 13 is a flow diagram illustrating a Method 256 for enabling and disabling a lifeform protection emitter 18, 20.

In FIG. 13 at Step 258, a lifeform with a lifeform protection emitter enters a land vehicle, water vehicle or an air vehicle. At Step 260, a lifeform detector/receiver in the land vehicle, water vehicle or air vehicle automatically senses the lifeform is inside the land vehicle, water vehicle or air vehicle and automatically turns the lifeform protection emitter off, thereby disabling the lifeform transmission system. At Step 262, the lifeform exits the land vehicle, water vehicle or air vehicle. At Step 264, the lifeform detector/receiver automatically senses the lifeform has existed and is outside the land vehicle, water vehicle or air vehicle and automatically turns the lifeform protection emitter on, thereby enabling the lifeform transmission system and allowing the collision avoidance system in the land vehicle, water vehicle or air vehicle to again sense and again avoid collisions with the lifeform.

Method 256 is illustrated with a preferred embodiment. However, the present invention is not limited to such a preferred embodiment, and other embodiments can be used to practice the invention.

In such a preferred embodiment, In FIG. 13 at Step 258, a lifeform 24, 30, 32 with a lifeform protection emitter 18, 20 enters a land vehicle 14, 28, 64, water vehicle 68 or air vehicle 60.

At Step 260, a lifeform detector/receiver 12 in the land vehicle 14, 28, 64, water vehicle 68 or air vehicle 60, automatically senses the lifeform 24, 30, 32 is inside the land vehicle 14, 28, 64, water vehicle 68 or air vehicle 60, and automatically turns the lifeform protection emitter 18, 20 off, thereby disabling the lifeform transmission system 10.

In one embodiment, the lifeform detector/receiver 12 in the land vehicle 14, 28, 64, water vehicle 68 or air vehicle 60 automatically senses lifeform vitals of the lifeform 24, 30, 32 including biometrics such as body temperature, blood pressure, heartbeat, pulse, respiration rate, oxygen consumption, etc. 42, 50 and/or equivalent of the lifeform 24, 30, 32 from the lifeform protection emitter 18, 20. However, the present invention is not limited to such embodiments and other embodiments may be used to practice the invention.

In another embodiment, lifeform detector/receiver 12 in the land vehicle 14, 28, 64, water vehicle 68 or air vehicle 60 automatically senses the lifeform 24, 30, 32 with one or more different sensors in the land vehicle 14, 28, 64, water vehicle 68 or air vehicle 60, including but not limited to air bag sensors, seatbelt sensors, engine ignition sensors, etc. However, the present invention is not limited to such embodiments and other embodiments may be used to practice the invention.

In another embodiment, lifeform detector/receiver 12 in the land vehicle 14, 28, 64, water vehicle 68 or air vehicle 60 automatically senses the lifeform 24, 30, 32 with GPS information 40, 52 on the lifeform protection emitter 18, 20 and determining the lifeform protection emitter 18, 20 is at a same physical location as the land vehicle 14, 28, 64, water vehicle 68 or air vehicle 60 based on the GPS information in the GPS component 13 in the land vehicle 14, 28, 64, water vehicle 68 or air vehicle 60. However, the present invention is not limited to such embodiments and other embodiments may be used to practice the invention.

At Step 262, the lifeform 24, 30, 32 exits the land vehicle 14, 28, 64, water vehicle 68 or air vehicle 60.

At Step 264, the lifeform detector/receiver 12 automatically senses the lifeform 24, 30, 32 has exited and is outside the land vehicle 14, 28, 64, water vehicle 68 or air vehicle 60, and automatically turns the lifeform protection emitter 18, 20 on, thereby enabling the lifeform transmission system 10 and allowing the collision avoidance system 15 in the land vehicle 14, 28, 64, water vehicle 68 or air vehicle 60, to again sense and again avoid collisions with the lifeform 24, 30, 32.

In one embodiment, the lifeform detector/receiver 12 automatically senses the biometrics of the lifeform 24, 30, 32, including a detectable pulse and/or a detectable heartrate 42, 50 and/or blood pressure and/or oxygen consumption and/or respiration rate, of the lifeform 24, 30, 32. However, the present invention is not limited to such an embodiment and other embodiments may be used to practice the invention.

In another embodiment, lifeform detector/receiver 12 in the land vehicle 14, 28, 64, water vehicle 68 or air vehicle 60 automatically senses the lifeform 24, 30, 32 is no longer activating any of one or more different sensors in the land vehicle 14, 28, 64, water vehicle 68 or air vehicle 60, including but not limited to air bag sensors, seatbelt sensors, engine ignition sensors, etc. However, the present invention is not limited to such embodiments and other embodiments may be used to practice the invention.

In another embodiment, lifeform detector/receiver 12 in the land vehicle 14, 28, 64, water vehicle 68 or air vehicle 60 automatically senses the lifeform 24, 30, 32 with GPS information 40, 52 on the lifeform protection emitter 18, 20 and determining the lifeform protection emitter 18, 20 is not at a same physical location as the land vehicle 14, 28, 64, water vehicle 68 or air vehicle 60 based on the GPS information in the GPS component 13 in the land vehicle 14, 28, 64, water vehicle 68 or air vehicle 60. However, the present invention is not limited to such embodiments and other embodiments may be used to practice the invention.

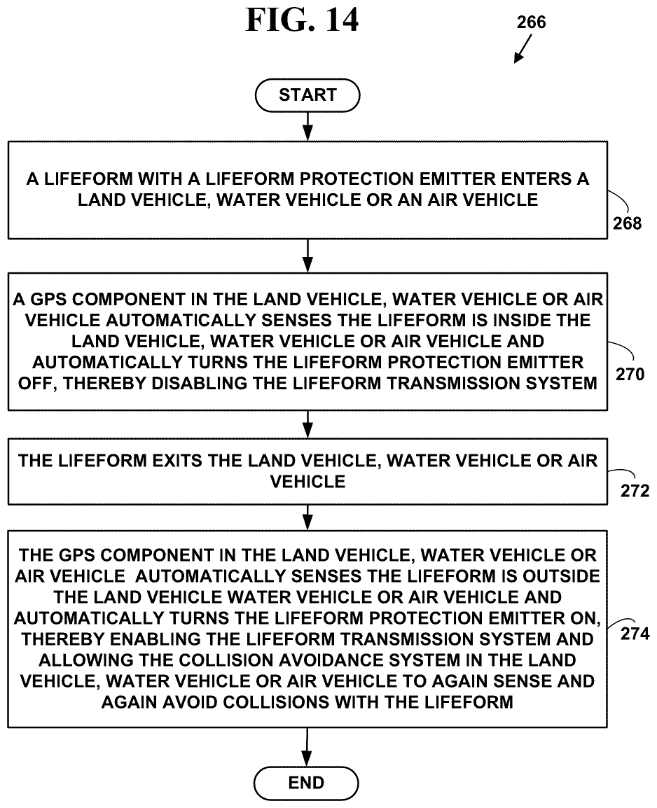

FIG. 14 is a flow diagram illustrating a Method 266 for enabling and disabling a lifeform protection emitter.

In FIG. 14 at Step 268, a lifeform with a lifeform protection emitter enters a land vehicle, water vehicle, or an air vehicle. At Step 270, a GPS component in the land vehicle, water vehicle, or air vehicle automatically senses the lifeform is inside land vehicle, water vehicle, or air vehicle and turns the lifeform protection emitter off, thereby disabling the lifeform transmission system. At Step 272, the lifeform exits the land vehicle, water vehicle or air vehicle. At Step 274, the GPS component in the land vehicle, water vehicle, or air vehicle automatically senses the lifeform has existed and is outside land vehicle, water vehicle, or air vehicle and turns the lifeform protection emitter on, thereby enabling the lifeform transmission system, and allowing the collision avoidance system in the land vehicle, water vehicle or air vehicle to again sense and again avoid collisions with the lifeform.

Method 266 is illustrated with a preferred embodiment. However, the present invention is not limited to such a preferred embodiment, and other embodiments can be used to practice the invention.

In such a preferred embodiment, In FIG. 14 at Step 268, a lifeform 24, 30, 32 with a lifeform protection emitter 18, 20 enters a land vehicle 14, 28, 64, water vehicle 68 or air vehicle 60.

At Step 270, a GPS component 13 in the land vehicle 14, 28, 64, water vehicle 68 or air vehicle 60 automatically senses the lifeform 24, 30, 32 is inside the land vehicle 14, 28, 64, water vehicle 68 or air vehicle 60 and turns the lifeform protection emitter 18, 20 off, thereby disabling the lifeform transmission system 10.

In one embodiment, the GPS component 13 in the land vehicle 14, 28, 64, water vehicle 68 or air vehicle 60 automatically senses a physical location of the lifeform 24, 30, 32, by reading GPS information 40, 52 on the lifeform protection emitter 18, 20 and determining the lifeform protection emitter 18, 20 is at a same physical location as the land vehicle 14, 28, 64, water vehicle 68 or air vehicle 60 based on its own GPS information in the GPS component 13. However, the present invention is not limited to such embodiments and other embodiments may be used to practice the invention.

At Step 272, the lifeform exits the land vehicle 14, 28, 64, water vehicle 68 or air vehicle 60.

At Step 274, the GPS component 13 in the land vehicle 14, 28, 64, water vehicle 68 or air vehicle 60 automatically senses the lifeform 24, 30, 32 has existed and is outside the land vehicle 14, 28, 64, water vehicle 68 or air vehicle 60 and turns the lifeform protection emitter 18, 20 on, thereby enabling the lifeform transmission system 10, and allowing the collision avoidance system 15 in the land vehicle 14, 28, 64, water vehicle 68 or air vehicle 60 to again sense and again avoid collisions with the lifeform 24, 30, 32.

In one embodiment, the GPS component 13 in the land vehicle 14, 28, 64, water vehicle 68 or air vehicle 60 automatically senses a physical location of the lifeform 24, 30, 32, by reading GPS information 40, 52 on the lifeform protection emitter 18, 20 and determining the lifeform protection emitter 18, 20 is not at a same physical location as the land vehicle 14, 28, 64, water vehicle 68 or air vehicle 60 based on its own GPS information in the GPS component 13. However, the present invention is not limited to such embodiments and other embodiments may be used to practice the invention.

In one specific embodiment of the invention, all components of the collision avoidance system (CAS) 15 are included in On-Board Diagnostic (OBD) component hat tis plugged into the OBD port in the land vehicle 14, 28, 64. However, the present invention is not limited to such and embodiment and the lifeform transmission system 10 can be used without an OBD component.

In one specific embodiment, all components of the collision avoidance system (CAS) 15 are included in an external network device 17 (e.g., cell phone, smart phone, electronic tablet, wearable, laptop computer, etc.) with a lifeform detection application 19 connected to a communications network 21 to control the lifeform protection emitter 18, 20 of the lifeform 24, 30, 32. The external network device 17 with the lifeform control application 19 is included within land vehicle 14, 28, 64, water vehicle 68 and/or air vehicle 60. However, the present invention is not limited to such and embodiment and the lifeform transmission system 10 can be used without the external network device 17.

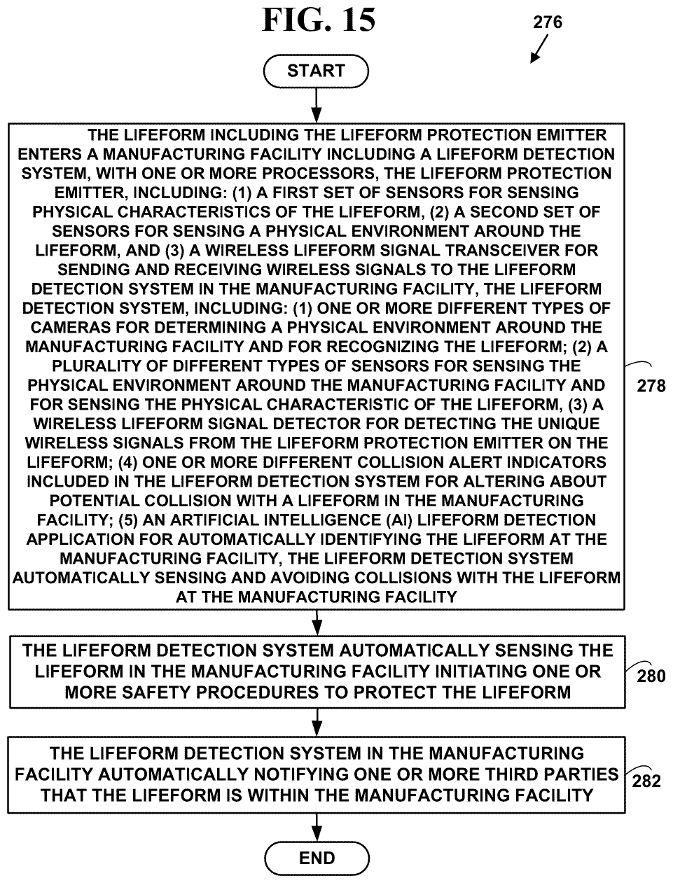

FIG. 15 is a flow diagram illustrating a Method 276 for enabling and disabling a lifeform protection. At Step 278, the lifeform including the lifeform protection emitter enters a manufacturing facility including a lifeform detection system, with one or more processors, the lifeform protection emitter, including: (1) a first set of sensors for sensing physical characteristics of the lifeform, (2) a second set of sensors for sensing a physical environment around the lifeform, and (3) a wireless lifeform signal transceiver for sending and receiving unique wireless signals to the lifeform detection system in the manufacturing facility, the lifeform detection system, including: (1) one or more different types of cameras for determining a physical environment around the manufacturing facility and for recognizing the lifeform; (2) a plurality of different types of sensors for sensing the physical environment around the manufacturing facility and for sensing the physical characteristic of the lifeform, (3) a wireless lifeform signal detector for detecting wireless signals from the lifeform protection emitter on the lifeform; (4) one or more different collision alert indicators included in the lifeform detection system for altering about potential collision with a lifeform in the manufacturing facility; (5) an artificial intelligence (AI) lifeform detection application for automatically identifying the lifeform at the manufacturing facility, the lifeform detection system automatically sensing and avoiding collisions with the lifeform at the manufacturing facility; At Step 280, the lifeform detection system automatically sensing the lifeform in the manufacturing facility initiating one or more safety procedures to protect the lifeform; and at Step 282, the lifeform detection system in the manufacturing facility automatically notifying one or more third parties that the lifeform is within the manufacturing facility.

Method 276 is illustrated with a preferred embodiment. However, the present invention is not limited to such a preferred embodiment, and other embodiments can be used to practice the invention.

In such a preferred embodiment, In FIG. 15 at Step 278, the lifeform 24, 30, 32 including the lifeform protection emitter 18, 20 enters a manufacturing facility 79 including a lifeform detection system 81, 12 with one or more processors, the lifeform protection emitter, 18, 20, including: (1) a first set of sensors 40, 50 for sensing physical characteristics of the lifeform 24, 30, 32, (2) a second set of sensors 42, 45, 52 for sensing a physical environment around the lifeform 24, 30, 32, and (3) a lifeform signal transceiver 49, 55, for sending and receiving unique wireless signals to the lifeform detection system 81, in the manufacturing facility 79, the lifeform detection system 81, 12 including: (1) one or more different types of cameras 71 for determining a physical environment around the manufacturing facility 79 and for determining the lifeform 24, 30, 32; (2) a plurality of different types of sensors 73 for sensing the physical environment around the manufacturing facility 79 for sensing the physical characteristic of the lifeform 24, 30, 32, (3) a lifeform signal detector 12, 75 for detecting the unique wireless signals from the lifeform protection emitter 18, 20 on the lifeform 24, 30, 32, (4) one or more different collision alert indicators 87 included in lifeform detection system 81 for altering about a potential collision with a lifeform 24, 30, 32 in the manufacturing facility 79, (5) an artificial intelligence (AI) lifeform detection application 19′ for automatically identifying the lifeform 24, 30, 32, the lifeform detection system 81 automatically sensing and avoiding collisions with the lifeform 24, 30, 32 at the manufacturing facility 79.

In one embodiment, the manufacturing facility 79, includes, but is not limited to, a factory, warehouse, steel mill, oil refinery, chemical plant, food processing plant, meat processing plant, etc. including a plurality of machines, robots, assembly lines, storage tanks including solid and liquid chemicals and materials, petroleum storage tanks, gas storage tanks, storage racks, etc. However, the present invention is not limited to this embodiment, and more, fewer and other types of manufacturing facilities can be used to practice the invention.

In one embodiment, one or more lifeform detection systems 81, 12 are placed in desired locations within the manufacturing facility 79. However, the present inventions is not limited to such an embodiment and other embodiment can be used to practice the invention.

At Step 280, the lifeform detection system 81, 12 automatically sensing the lifeform in the manufacturing facility 79 initiating one or more safety procedures to protect the lifeform 24, 30, 32.

In one embodiment, the one or more safety procedures includes, turning off electricity to a specific machine, turning on electricity to a specific machine, locking a door, unlocking a door, turning a robot off and on, turning pipe lines and valves on and off, warning the lifeform 24, 30, 32 about dangers in the manufacturing facility 79 such as dangerous machines, dangerous fumes and/or gases, etc. However, the present invention is not limited to such and embodiment and other embodiments can be used to practice the invention.

At Step 282, the lifeform detection system 81, 12 in the manufacturing facility 79 automatically notifying one or more third parties that the lifeform 24, 30, 32 is within the manufacturing facility 79

In one embodiment, the lifeform detection system 81, 12 automatically sends wireless signals to another network device 17 via a wireless communications network 21 to indicate the activities of the lifeform 24, 30, 32 in the manufacturing facility 79 as an additional safety measure. In such an embodiment, a third-party is able to keep track of the lifeform to help ensure its safety in the manufacturing facility 79.

In one embodiment, the one or more different collision alert indicators 87 include visual alert indictors (e.g., flashing lights, etc.), audio alert indicators (e.g., a horn, whistle, voice announcement, etc.) and/or a control system alert indicator (e.g., opening/locking a door, opening/locking a gate, turning power on/off to a light, ski lift, harbor light, etc.) and/or a wireless transmitter to transmit wireless alert signals to the lifeform signal transceiver 49, 55 on the lifeform 24, 30, 32 and/or a combination thereof. In one embodiment, the wireless alert signals sent to the lifeform signal transceiver 49, 55 on the lifeform 24, 30, 32, include, but are not limited to, wireless alert signals including an audio sound such as an alarm sound (e.g., a beep, etc.), a voice announcement (e.g., say “watch out,” etc.) and/or generation of a vibration, etc. and/or a combination thereof. However, the present invention is not limited to this embodiment, and more, fewer and other types of different collision alert indicators 87 can be used to practice the invention.

In another specific embodiment, the lifeform transmission system 10 includes use for manufacturing safety. When a technician needs to enter an area including a large and potentially dangerous manufacturing machine and/or robot, for tool maintenance or fix, the lifeform protection emitter 18 communicates with the lifeform detector/receiver 12 in a tool area around the dangerous manufacturing machine or robot. The tool area is locked or locked out with the lifeform transmission system 10 so another human cannot come into the tool area and operate the dangerous machine and/or robot while the technician is in the area for the technician safety. In this embodiment, the lifeform protection emitter 18, 20 increases worker safety and decreases corporate liability.

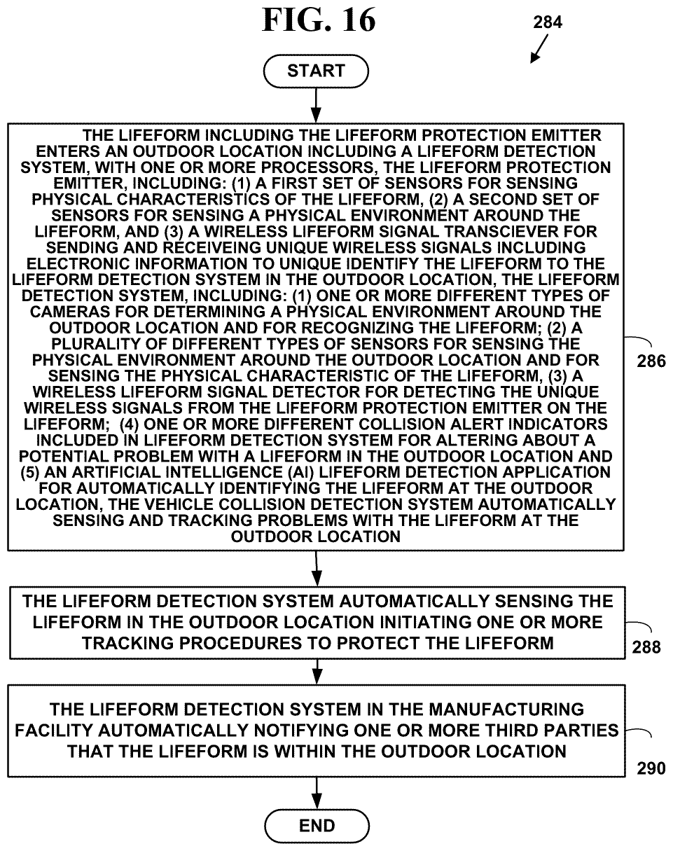

FIG. 16 is a flow diagram illustrating a Method 284 for enabling and disabling a lifeform protection.

In FIG. 16, At Step 286, the lifeform including the lifeform protection emitter enters an outdoor location including a lifeform detection system, with one or more processors, the lifeform protection emitter, including: (1) a first set of sensors for sensing physical characteristics of the lifeform, (2) a second set of sensors for sensing a physical environment around the lifeform, and (3) a wireless lifeform signal transeciver for sending and receiving unique wireless signals including electronic information to unique identify the lifeform to the lifeform detection system in the outdoor location, the lifeform detection system, including: (1) one or more different types of cameras for determining a physical environment around the outdoor location and for recognizing the lifeform; (2) a plurality of different types of sensors for sensing the physical environment around the outdoor location and for sensing the physical characteristic of the lifeform, (3) a wireless lifeform signal detector for detecting wireless signals from the lifeform protection emitter on the lifeform; (4) one or more different collision alert indicators included in lifeform detection system for altering about a potential problem with a lifeform in the outdoor location and (5) an artificial intelligence (AI) lifeform detection application for automatically identifying the lifeform, the vehicle collision detection system automatically sensing and tracking problems with the lifeform at the outdoor location; At Step 288, the lifeform detection system automatically sensing the lifeform in the outdoor location initiating one or more real-time tracking procedures to protect the lifeform; and At Step 290, the lifeform detection system in the outdoor location automatically notifying one or more third parties that the lifeform is within the outdoor location.

Method 284 is illustrated with a preferred embodiment. However, the present invention is not limited to such a preferred embodiment, and other embodiments can be used to practice the invention.

In such a preferred embodiment, In FIG. 16 at Step 286, the lifeform 24, 30, 32 including the lifeform protection emitter 18, 20 enters an outdoor location 83 including a lifeform detection system 85, with one or more processors, the lifeform protection emitter, 18, 20, including: (1) a first set of sensors 40, 50 for sensing physical characteristics of the lifeform 24, 30, 32, (2) a second set of sensors 42, 45, 52 for sensing a physical environment around the lifeform 24, 30, 32, and (3) a lifeform signal transceiver 49, 55, for sending and receiving unique wireless signals including electronic information to unique identify the lifeform to the lifeform detection system 85, in the outdoor location 83, the lifeform detection system 83, including: (1) one or more different types of cameras 71 for determining a physical environment around the outdoor location 83 and for determining the lifeform 24, 30, 32; (2) a plurality of different types of sensors 73 for sensing the physical environment around the outdoor location 93 and for sensing the physical characteristic of the lifeform 24, 30, 32, and (3) a lifeform signal detector 12, 75 for detecting the wireless signals from the lifeform protection emitter 18, 20 on the lifeform 24, 30, 32, (4) one or more different collision alert indicators 87 included in lifeform detection system 85 for altering about a potential problem with a lifeform 24, 30, 32 in the outdoor location 83, and (5) an artificial intelligence (AI) lifeform detection application 19′ for automatically identifying the lifeform 24, 30, 32, the life form collision detection system automatically sensing and tracking problems for the lifeform 24, 30, 32 at the outdoor location 83.

In one embodiment, the outdoor location, includes, but is not limited to, an ocean, lake, stream, ski hill, cave entrance, park, hiking trail, mountain, national park, forest, etc. However, the present invention is not limited to such and embodiment and other embodiments can be used to practice the invention.

In one embodiment, the one or more different collision alert indicators 87 include visual alert indictors (e.g., flashing lights, etc.), audio alert indicators (e.g., a horn, whistle, voice announcement, etc.) and/or a control system alert indicator (e.g., opening/locking a door, opening/locking a gate, turning power on/off to a light, ski lift, harbor light, etc.) and/or a wireless transmitter to transmit wireless alert signals to the lifeform signal transceiver 49, 55 on the lifeform 24, 30, 32 and/or a combination thereof. In one embodiment, the wireless alert signals sent to the lifeform signal transceiver 49, 55 on the lifeform 24, 30, 32, include, but are not limited to, wireless alert signals including an audio sound such as an alarm sound (e.g., a beep, etc.), a voice announcement (e.g., say “watch out,” etc.) and/or generation of a vibration, etc. and/or a combination thereof. However, the present invention is not limited to this embodiment, and more, fewer and other types of different collision alert indicators 87 can be used to practice the invention.

In one embodiment, one or more lifeform detection systems 85, 12 are placed in one or more desired locations in, on, within and/or around the outdoor location 83. For example, on poles, towers, buildings, natural land features, etc. on land and/or on buoys, docks, lights, lighthouses, breakwaters, etc. However, the present inventions is not limited to such an embodiment and other embodiment can be used to practice the invention.

At Step 288, the lifeform detection system 85, 12 automatically sensing the lifeform in the outdoor location 83 initiating one or more real-time tracking procedures to protect the lifeform 24, 30, 32.

In one embodiment, the one or more tracking procedures include, but are not limited to, dynamically tracking a current physical location of the lifeform 24, 30, 32 (e.g., GPS location information from GPS component 40, 52 in lifeform protection emitter 18, 20 etc.). However, the present invention is not limited to such and embodiment and other embodiments can be used to practice the invention.

At Step 290, the lifeform detection system 85, 12 in the outdoor location 83 automatically notifying one or more third parties that the lifeform 24, 30, 32 is within the outdoor location 83.

In one embodiment, the lifeform detection system 81 automatically sends wireless signals to another network device 17 via a wireless communications network 21 to indicate the activities of the lifeform 24, 30, 32 in outdoor location 83 as an additional safety measure. In such an embodiment, a third-party is able to keep track of the lifeform to help ensure its safety in the outdoor location 83 in the event of an emergency.

In another embodiment, the lifeform transmission system 10 includes use for outdoor safety. When a lifeform 30, 32 enters a cave, goes mountain climbing, canoeing, kayaking, surfing, etc. the lifeform protection emitter 18 communicates with one or more different lifeform detector/receivers 83, 12 including a lifeform detection application 19 placed near and/or directly in areas such outdoor activities occur (e.g., ocean, lake, stream, ski hill, cave entrance, park, hiking trail, mountain, etc.). In this embodiment, the lifeform protection emitter 18, 20 in combination with detector/receivers 83, 12 including a lifeform detection application 19 increases lifeform 30, 32 safety and also assists with searcher activities for a lifeform 30, 32 in the event of any emergency (See. FIGS. 5A-5C and related text).

In one embodiment, the device 18, 20, 36, 48 may be wearable somewhere on the body, an implant (e.g., a NEURALINK, etc.), or carriable 17 as long as a specific reading can be determined 12, 81, 85 that the wearer 24, 30, 32 and/or carrier of the device 17 is alive, human, pet and/or other animal. The device 18, 20, 36, 48, may also be used where areas of safety are of concern such as manufacturing where lockout tags are used and/or required in dangerous situations.

Methods 216, 226, 236, 246, 256, 266, 276, 284 in FIGS. 9-16 are illustrated with one or two lifeforms. However, the present invention is not limited to such embodiments and other embodiments with plural lifeforms can be used to practice the inventions. For example, a human parent 30 with plural children 32 each with a lifeform protection emitter 18, a human with plural animals 24 (e.g., dogs, cats, cattle, horses, pigs, chickens, zoo animals, wild animals, etc.) each with a lifeform protection emitter 20, enters and exits the land vehicle 14, 28, 64, water vehicle 68 or air vehicle 60, etc.

While the drawings represent a typical example where the lifeform transmission system of the present invention can be used, the lifeform transmission system is also fully compatible with a self-driving vehicle, a robot car, an autonomous car, and/or a driverless car, an Unmanned Airial Vehicle (UAV), drone, Unmanned Water Vehicle (UWV), etc. and/or any other types of vehicles.

The lifeform detection for collision avoidance system of the present invention includes the following: a lifeform transmitter, worn, attached, or carried by various lifeforms such as, but not limited to, infants, children, adults, dogs, cats, other pets, livestock, zoo animals, wild animals, etc. Vitals sensor on the lifeform transmitter are used to identify the wearer as a lifeform (e.g., using temperature, pulse, motion, electrical stimuli, etc.) The lifeform transmitter, provides the communication loop between pedestrian and autonomous vehicle for increased certainty of collision avoidance. Augmenting autonomous (i.e., self-driving and autonomous) vehicles systems to make informed directional, path, and speed adjustments for recognized lifeforms using the device. May include lifeforms receiving information through the device acknowledging proximity or proximity of approaching vehicle.

It is evident that many alternatives, modifications, and variations of the lifeform detection for collision avoidance system of the present invention will be apparent to those skilled in the art in light of the disclosure herein. For example, the system can be used for personal use as well as by personal trainers and those with ailments, such as cerebral palsy, to aid them in improving their coordination. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

It should be understood that the architecture, programs, processes, methods and systems described herein are not related or limited to any particular type of computer or network system (hardware or software), unless indicated otherwise. Various types of specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended.

Therefore, all embodiments that come within the scope and spirit of the following claims and equivalents thereto are claimed as the invention.

We claim:

1. A method for enabling and disabling a lifeform protection system, comprising:
sensing automatically on a lifeform application on a lifeform protection emitter with one or more processors, that a lifeform including the lifeform protection emitter has entered a land vehicle, water vehicle, or an air vehicle including a collision detection system, with one or more processors,
the lifeform protection emitter, including: (1) a first set of sensors for sensing physical characteristics of the lifeform, (2) a second set of sensors for sensing a physical environment around the lifeform, and (3) the wireless lifeform signal transceiver for sending and receiving unique wireless signals with identifying information about the lifeform to the lifeform detection system to the vehicle collision detection system in the land vehicle, the water vehicle, or the air vehicle,
the vehicle collision detection system, including: (1) one or more different types of cameras for determining a physical environment around the land vehicle, the water vehicle, or the air vehicle, and for recognizing the lifeform; (2) a plurality of different types of sensors for sensing the physical environment around the land vehicle, the water vehicle, or the air vehicle and for sensing the physical characteristic of the lifeform, (3) a wireless lifeform signal detector for detecting the unique wireless signals from the lifeform protection emitter on the lifeform, (4) one or more different collision alert indicators included in the vehicle collision detection system for altering a driver of the land vehicle, the water vehicle, or the air vehicle about a potential collision with a lifeform, and (5) an artificial intelligence (AI) lifeform detection application for automatically identifying the lifeform, the vehicle collision detection system automatically sensing and avoiding collisions between the lifeform and the land vehicle, the water vehicle, or the air vehicle;
the vehicle collision detection system automatically sensing and avoiding collisions between the lifeform and the land vehicle, the water vehicle, or the air vehicle;
automatically turning the lifeform signal transmitter off from the lifeform application on the lifeform protection emitter,
thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform;
sensing automatically on the lifeform application on the lifeform protection emitter that the lifeform including the lifeform protection emitter has exited the land vehicle, the water vehicle, or the air vehicle including the collision detection system; and
automatically turning the lifeform signal transmitter on from the lifeform application on the lifeform protection emitter,
thereby enabling the lifeform protection emitter and enabling the collision avoidance system in the land vehicle, the water vehicle, or the air vehicle for detecting the lifeform with the lifeform protection emitter to again sense the lifeform and enabling the collision avoidance system in the land vehicle, the water vehicle, or the air vehicle, to again avoid collisions with the lifeform.

2. The method of claim 1 wherein, the lifeform includes a human, an animal lifeform or an object worn on the lifeform.

3. The method of claim 1 wherein, the unique wireless signals sent from the lifeform protection emitter including electronic information including: a unique hardware address including, network, phone number, user name, unique network identifier, Globally Unique Identifier (GUID), Universally Unique Identifier (UUID), encrypted token, stored contact, database record or cloud database record.

4. The method of claim 1 wherein, the lifeform protection emitter includes an electronic fitness watch, electronic medical monitoring device, electronic fitness bracelet, electronic medical bracelet, wearable network device comprising: watches, bracelets, glasses, sensors or monitors, smart phone or electronic tablet, lifeform protection emitter.

5. The method of claim 1, wherein (1) the land vehicle includes: an automobile, truck, bus, locomotive, bicycle, motorcycle, farm vehicle, construction vehicle or sports vehicle, (2) the air vehicle includes: an airplane, helicopter, unmanned aerial vehicle (UAV), drone or airship, and (3) the water vehicle includes: a boat, ship, personal watercraft (PWC), unmanned water vehicle (UWV), canoe, raft or kayak.

6. The method of claim 1, wherein first set of sensors for sensing physical characteristics of the lifeform includes a plurality of sensors for sensing lifeform vitals of the lifeform including lifeform biometrics comprising: body temperature, blood pressure, heartbeat, pulse, oxygen consumption, respiration rate, or combination thereof.

7. The method of claim 1, wherein second set of sensors for sensing a physical environment around the lifeform includes a plurality of sensors comprising light sensor component, air pressure component, an altimeter component, a speed component, a pace component, a position component a velocity component, an acceleration component, a Global Positioning System (GPS) component, or combination thereof.

8. The method of claim 1, wherein the one or more different types of cameras include visual cameras, thermal imaging cameras, or acoustic imaging cameras, or a combination thereof.

9. The method of claim 1, wherein the plurality of different types of sensors for sensing the physical environment around the land vehicle, the water vehicle, or the air vehicle, and for sensing the physical characteristic of the lifeform, a plurality of sensors comprising light sensor component, air pressure component, an altimeter component, a speed component, a position component, a velocity component, an acceleration component, a Global Positioning System (GPS) component, radar component, Light Detection And Ranging (LiDAR) component, Light Detection and Ranging (LADAR) component, sonar component, air bag seat sensors, seatbelt sensors, engine ignition sensors, or a combination thereof.

10. The method of claim 1, wherein the wireless signal transceiver on the lifeform protection emitter and the wireless signal detector on the collision avoidance system in the land vehicle, the water vehicle, or the air vehicle include one or more of a: AM radio, FM radio, satellite radio, cellular telephone, 802.11a, 802.11b, 802.11g, 802.11n, 802.15.4 (ZigBee), Wireless Fidelity (Wi-Fi), Wi-Fi Aware, Worldwide Interoperability for Microwave Access (WiMAX), ETSI High Performance Radio Metropolitan Area Network (HIPERMAN), Near Field Communications (NFC), Machine-to-Machine (M2M), BLUETOOTH, Radio Frequency Identifier (RFID), infrared, satellite, aviation, marine, or a combination thereof, wireless signal transmitters and wireless signal detectors.

11. The method of claim 1 further comprising, wherein all components of the collision avoidance system are included in: (1) an On-Board Diagnostic (OBD) component that is plugged into an OBD port in the land vehicle; (2) an external network device with a lifeform detection application included within land vehicle, water vehicle or air vehicle, the external network device comprising: a cell phone, smart phone, electronic tablet, wearable network device or laptop computer.

12. The method of claim 1 wherein, the one or more different collision alert indicators included in the vehicle collision detection system for altering a driver of the land vehicle include, visual indicators, audio alert indicators or control alert indicators and one or more unique wireless signals sent to lifeform protection emitter on the lifeform.

13. The method of claim 1, wherein the vehicle collision detection system includes an Artificial Intelligence (AI) application, one or more AI methods for: human facial recognition, human shape form recognition, animal shape form recognition; human sound recognition, animal sound recognition, human biometrics recognition and analysis, animal biometrics recognition and analysis; and/or other AI methods using (1) the one or more different types of cameras for determining a physical environment around the land vehicle, the water vehicle, or the air vehicle, and for determining the lifeform, (2) the plurality of different types of sensors for sensing the physical environment around the land vehicle, the water vehicle, or the air vehicle, and for sensing the physical characteristic of the lifeform, and (3) the lifeform signal detector for detecting the unique wireless signals from the lifeform protection emitter on the lifeform.

14. The method of claim 1, further comprising:
sensing automatically on the collision detection system on the land vehicle, the water vehicle, or the air vehicle, that the lifeform including the lifeform protection emitter and the lifeform application has entered the land vehicle, the water vehicle, or the air vehicle;
automatically turning the lifeform signal transmitter off via the lifeform application on the lifeform protection emitter from the vehicle collision detection system on the land vehicle, the water vehicle, or the air vehicle,
thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform;
sensing automatically on the collision detection system on the land vehicle, the water vehicle, or the air vehicle that the lifeform including the lifeform protection emitter has exited the land vehicle, the water vehicle, or the air vehicle with the collision detection system; and
automatically turning the lifeform signal transmitter on from collision detection system on the land vehicle, the water vehicle, or the air vehicle via the lifeform application on the lifeform protection emitter,
thereby enabling the lifeform protection emitter and enabling the collision avoidance system in the land vehicle, the water vehicle, or the air vehicle for detecting the lifeform with the lifeform protection emitter to again sense and enabling the collision avoidance system in the land vehicle, the water vehicle, or the air vehicle again avoid collisions with the lifeform.

15. The method of claim 14, wherein the step of sensing automatically on the collision detection system on the land vehicle, the water vehicle, or the air vehicle, that the lifeform including the lifeform protection emitter and the lifeform application has entered the land vehicle, the water vehicle, or the air vehicle includes sensing automatically on the collision detection system on the land vehicle, the water vehicle, or the air vehicle with a Global Position System (GPS) component from the plurality of different types of sensors for sensing the physical environment around the land vehicle, the water vehicle, or the air vehicle, and for sensing the physical characteristic of the lifeform.

16. The method of claim 1, further comprising:
the lifeform entering the land vehicle, the water vehicle, or the air vehicle, with the lifeform including the lifeform protection emitter and the lifeform application;
the lifeform turning the lifeform signal transmitter off via the lifeform application on the lifeform protection emitter;
thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform;
the lifeform exiting the land vehicle, the water vehicle, or the air vehicle, the lifeform including the lifeform protection emitter and the lifeform application; and
the lifeform turning the lifeform signal transmitter on via the lifeform application on the lifeform protection emitter,
thereby enabling the lifeform protection emitter and enabling the collision avoidance system in the land vehicle, the water vehicle, or the air vehicle for detecting the lifeform with the lifeform protection emitter to again sense and enabling the collision avoidance system in the land vehicle, the water vehicle, or the air vehicle again avoid collisions with the lifeform.

17. The method of claim 16, wherein the lifeform further includes, another second lifeform different from the lifeform already within the land vehicle, the water vehicle, or the air vehicle.

18. The method of claim 16, wherein the steps of turning the lifeform signal transmitter off via the lifeform with the lifeform application on the lifeform protection emitter and turning the lifeform signal transmitter on via the lifeform with the lifeform application on the lifeform protection emitter include:
turning the lifeform signal transmitter on and off via a graphical menu option on the lifeform application on the lifeform protection emitter.

19. The method of claim 1, further comprising:
a plurality of lifeforms entering the land vehicle, the water vehicle, or the air vehicle, the plurality of lifeforms including a plurality of lifeform protection emitters and a plurality of lifeform applications;
turning the plurality of lifeform signal transmitters off via the plurality of lifeform applications for the plurality of lifeforms from via an administrative lifeform within land vehicle, the water vehicle, or the air vehicle, with a second lifeform application on a second lifeform protection emitter included on the administrative lifeform,
thereby disabling the plurality of lifeform protection emitters and disabling the collision avoidance system in the land vehicle, the water vehicle, or the air vehicle from detecting the plurality of lifeforms with the plurality of lifeform protection emitters and disabling the collision avoidance system in the land vehicle, the water vehicle, or the air vehicle from automatically sensing and avoiding collisions with the plurality of lifeforms;
the plurality of lifeforms exiting the land vehicle, the water vehicle, or the air vehicle, the plurality of lifeforms exiting the water vehicle, or the air vehicle including the plurality of lifeform protection emitters and the plurality of lifeform applications; and
turning the lifeform signal transmitters on via the plurality of lifeform applications on the plurality of lifeform protection emitters for the plurality of lifeforms exiting the land vehicle, the water vehicle, or the air vehicle, via the administrative lifeform within land vehicle, the water vehicle, or the air vehicle, with a second lifeform application on a second lifeform protection emitter included on the administrative lifeform,
thereby enabling the plurality of lifeform protection emitters and enabling the collision avoidance system in the land vehicle, the water vehicle, or the air vehicle for detecting the plurality of lifeforms with the plurality of lifeform protection emitters to again sense and enabling the collision avoidance system in the land vehicle, the water vehicle, or the air vehicle again avoid collisions with the plurality of lifeforms.

20. The method of claim 19, further comprising:
only selected ones of the plurality of lifeforms exiting the land vehicle, the water vehicle, or the air vehicle; and
turning the lifeform signal transmitters on for the selected ones of the plurality of lifeforms exiting the land vehicle, the water vehicle, or the air vehicle, via the administrative lifeform within land vehicle, the water vehicle, or the air vehicle, with the second lifeform application on the second lifeform protection emitter included on the administrative lifeform,
thereby enabling the selected ones of the of lifeform protection emitters of the plurality of lifeforms exiting the land vehicle, the water vehicle, or the air vehicle and enabling the collision avoidance system in the land vehicle, the water vehicle, or the air vehicle for detecting the selected ones of the plurality of lifeforms to again sense and enabling the collision avoidance system in the land vehicle, the water vehicle, or the air vehicle again avoid collisions with the selected ones of the plurality of lifeforms.

21. The method of claim 1, further comprising:
the lifeform including the lifeform protection emitter enters a manufacturing facility including a lifeform detection system, with one or more processors,
the lifeform protection emitter, including: (1) the first set of sensors for sensing physical characteristics of the lifeform, (2) the second set of sensors for sensing a physical environment around the lifeform, and (3) the wireless lifeform signal transceiver for sending and receiving unique wireless signals with identifying information about the lifeform to the lifeform detection system in the manufacturing facility,
the lifeform detection system, including: (1) one or more different types of cameras for determining a physical environment around the manufacturing facility and for recognizing the lifeform; (2) a plurality of different types of sensors for sensing the physical environment around the manufacturing facility and for sensing the physical characteristic of the lifeform, (3) a wireless lifeform signal detector for detecting the unique wireless signals from the lifeform protection emitter on the lifeform and identifying the lifeform, (4) one or more different collision alert indicators included the lifeform detection system for altering about potential collisions with the lifeform in the manufacturing facility, and (5) an artificial intelligence (AI) lifeform detection application for automatically identifying the lifeform in the manufacturing facility,
the lifeform detection system automatically sensing the lifeform in the manufacturing facility and initiating one or more safety procedures to protect the lifeform; and
the lifeform detection system in the manufacturing facility automatically notifying one or more third parties that the lifeform is within the manufacturing facility.

22. The method of claim 1, further comprising:
the lifeform including the lifeform protection emitter enters an outdoor location including a lifeform detection system, with one or more processors,
the lifeform protection emitter, including: (1) the first set of sensors for sensing physical characteristics of the lifeform, (2) the second set of sensors for sensing a physical environment around the lifeform, and (3) the wireless lifeform signal transceiver for sending and receiving unique wireless signals with identifying information about the lifeform to the lifeform detection system in the outdoor location,
the lifeform detection system, including: (1) one or more different types of cameras for determining a physical environment around the outdoor location and for recognizing the lifeform; (2) a plurality of different types of sensors for sensing the physical environment around the outdoor location and for sensing the physical characteristic of the lifeform, and (3) a wireless lifeform signal detector for detecting the unique wireless signals from the lifeform protection emitter on the lifeform; (4) one or more different collision alert indicators included the lifeform detection system for altering about potential collisions with the lifeform at the outdoor location, and (5) an artificial intelligence (AI) lifeform detection application for automatically identifying the lifeform at the outdoor location;
the lifeform detection system automatically sensing the lifeform in the outdoor location and initiating one or more tracking procedures to protect the lifeform; and
the lifeform detection system in the outdoor location automatically notifying one or more third parties that the lifeform is within the outdoor location.

23. A non-transitory computer readable having stored therein a plurality of instructions for causing one or more processors to execute a plurality of steps, comprising:
sensing automatically on a lifeform application on a lifeform protection emitter with one or more processors, that a lifeform including the lifeform protection emitter has entered a land vehicle, water vehicle, or an air vehicle including a collision detection system, with one or more processors,
the lifeform protection emitter, including: (1) a first set of sensors for sensing physical characteristics of the lifeform, (2) a second set of sensors for sensing a physical environment around the lifeform, and (3) the wireless lifeform signal transceiver for sending and receiving unique wireless signals with identifying information about the lifeform to the lifeform detection system to the vehicle collision detection system in the land vehicle, the water vehicle, or the air vehicle, the vehicle collision detection system, including: (1) one or more different types of cameras for determining a physical environment around the land vehicle, the water vehicle, or the air vehicle, and for recognizing the lifeform; (2) a plurality of different types of sensors for sensing the physical environment around the land vehicle, the water vehicle, or the air vehicle and for sensing the physical characteristic of the lifeform, (3) a wireless lifeform signal detector for detecting the unique wireless signals from the lifeform protection emitter on the lifeform, (4) one or more different collision alert indicators included in the vehicle collision detection system for altering a driver of the land vehicle, the water vehicle, or the air vehicle about a potential collision with a lifeform, and (5) an artificial intelligence (AI) lifeform detection application for automatically identifying the lifeform, the vehicle collision detection system automatically sensing and avoiding collisions between the lifeform and the land vehicle, the water vehicle, or the air vehicle;
the vehicle collision detection system automatically sensing and avoiding collisions between the lifeform and the land vehicle, the water vehicle, or the air vehicle;
automatically turning the lifeform signal transmitter off from the lifeform application on the lifeform protection emitter,
thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform;
sensing automatically on the lifeform application on the lifeform protection emitter that the lifeform including the lifeform protection emitter has exited the land vehicle, the water vehicle, or the air vehicle including the collision detection system; and
automatically turning the lifeform signal transmitter on from the lifeform application on the lifeform protection emitter,
thereby enabling the lifeform protection emitter and enabling the collision avoidance system in the land vehicle, the water vehicle, or the air vehicle for detecting the lifeform with the lifeform protection emitter to again sense the lifeform and enabling the collision avoidance system in the land vehicle, the water vehicle, or the air vehicle, to again avoid collisions with the lifeform.

24. A system for enabling and disabling a lifeform protection, comprising in combination:
a land vehicle, water vehicle or air vehicle;
a vehicle collision detection system with one or more processors, in the land vehicle, the water vehicle, or the air vehicle, for avoiding collisions with a lifeform;
a lifeform protection emitter on the lifeform with one or more processors and a lifeform application, for sending wireless signals to the vehicle collision detection system;
for sensing automatically on a lifeform application on a lifeform protection emitter with one or more processors, that a lifeform including the lifeform protection emitter has entered a land vehicle, water vehicle, or an air vehicle including a collision detection system, with one or more processors,
the lifeform protection emitter, including: (1) a first set of sensors for sensing physical characteristics of the lifeform, (2) a second set of sensors for sensing a physical environment around the lifeform, and (3) the wireless lifeform signal transceiver for sending and receiving unique wireless signals with identifying information about the lifeform to the lifeform detection system to the vehicle collision detection system in the land vehicle, the water vehicle, or the air vehicle,
the vehicle collision detection system, including: (1) one or more different types of cameras for determining a physical environment around the land vehicle, the water vehicle, or the air vehicle, and for recognizing the lifeform; (2) a plurality of different types of sensors for sensing the physical environment around the land vehicle, the water vehicle, or the air vehicle and for sensing the physical characteristic of the lifeform, (3) a wireless lifeform signal detector for detecting the unique wireless signals from the lifeform protection emitter on the lifeform, (4) one or more different collision alert indicators included in the vehicle collision detection system for altering a driver of the land vehicle, the water vehicle, or the air vehicle about a potential collision with a lifeform, and (5) an artificial intelligence (AI) lifeform detection application for automatically identifying the lifeform, the vehicle collision detection system automatically sensing and avoiding collisions between the lifeform and the land vehicle, the water vehicle, or the air vehicle;
the vehicle collision detection system automatically sensing and avoiding collisions between the lifeform and the land vehicle, the water vehicle, or the air vehicle;
for automatically turning the lifeform signal transmitter off from the lifeform application on the lifeform protection emitter,
thereby disabling the lifeform protection emitter and disabling the collision avoidance system in the land vehicle, the water vehicle, or the air vehicle from detecting the lifeform with the lifeform protection emitter and disabling the collision avoidance system in the land vehicle, the water vehicle, or the air vehicle from automatically sensing and avoiding collisions with the lifeform;
for sensing automatically on the lifeform application on the lifeform protection emitter that the lifeform including the lifeform protection emitter has exited the land vehicle, the water vehicle, or the air vehicle including the collision detection system; and
for automatically turning the lifeform signal transmitter on from the lifeform application on the lifeform protection emitter,
thereby enabling the lifeform protection emitter and enabling the collision avoidance system in the land vehicle, the water vehicle, or the air vehicle for detecting the lifeform with the lifeform protection emitter to again sense the lifeform and enabling the collision avoidance system in the land vehicle, the water vehicle, or the air vehicle, to again avoid collisions with the lifeform.
